(19) United States
(12) Patent Application Publication
(10) Pub. No.: US 2009/0264614 A1
(43) Pub. Date: Oct. 22, 2009

(54) PROCESS FOR PRODUCING POWDERED THERMOPLASTIC POLYURETHANE UREA RESIN

(75) Inventors: Masahiro Hayashi, Kanagawa (JP); Motomu Kita, Kanagawa (JP); Hideyuki Tezen, Kanagawa (JP); Yuriko Minami, Kanagawa (JP)

Correspondence Address: SUGHRUE-265550, 2100 PENNSYLVANIA AVE. NW, WASHINGTON, DC, 20037-3213, US

(73) Assignee: NIPPON POLYURETHANE INDUSTRY CO., LTD., Tokyo (JP)

(21) Appl. No.: 12/065,965

(22) PCT Filed: May 30, 2006
(86) PCT No.: PCT/JP2006/310797

§ 371 Date: Mar. 6, 2008

(30) Foreign Application Priority Data
Sep. 6, 2005 (JP) 2005-257900
Oct. 26, 2005 (JP) 2005-311076

(51) Int. Cl. C08G 18/65

(52) U.S. Cl. 528/85

(57) ABSTRACT

A process for producing a powdered thermoplastic polyurethane urea resin is disclosed, which includes a step of forming a polyurethane urea resin by reacting a polymer polyol (a), an organic polyisocyanate (b), a monofunctional active hydrogen-containing compound (c), and preferably a bifunctional active hydrogen-containing compound (d) in specific proportions to form an isocyanate-terminated prepolymer, and subjecting the isocyanate-terminated prepolymer and water (e) to chain extension reaction in a non-aqueous dispersion medium. According to this production process, a powdered thermoplastic polyurethane urea resin having excellent melt formability can be obtained, and it is easy to control a molecular weight of the polyurethane urea resin.

### TECHNICAL FIELD

The present invention relates to a process for producing a powdered thermoplastic polyurethane urea resin suitably used to slush molding or the like.

### BACKGROUND ART

Slush molding can efficiently form a product having a complicated shape and a uniform wall thickness, and therefore is widely used in applications such as interior materials of automobiles.

Recently, a powdered thermoplastic polyurethane resin having excellent flexibility is employed as a material for slush molding.

The present applicant has proposed a production process including a step of chain extension by reacting an isocyanate-terminated prepolymer dispersed in a non-aqueous dispersion medium with water as a process for producing a powder polyurethane resin (polyurethane urea resin) for slush molding that can obtain a molding in which blooming is difficult to be generated and crease is difficult to be formed (see Patent Document 1).

Patent Document 1 further discloses that after a part of isocyanate groups of the isocyanate-terminated prepolymer is reacted with a low molecular polyol or the like, the remainder of the isocyanate group is reacted with water.

Patent Document 1: JP-A-2004-161866

### DISCLOSURE OF THE INVENTION

### Problems to be Solved by the Invention

However, there is the problem that by locally reacting an isocyanate with water (for example, urea bond formed by the reaction between an isocyanate and water is localized by its strong hydrogen bonding force, and local ureation reaction is accelerated) in the production process of a powdered thermoplastic polyurethane urea resin, a sparingly-fusible material having an excessively large molecular weight (a sparingly-fusible material in which flowing is observed at a position that is considered to have an ultrahigh molecular weight in gel permeation chromatography (hereinafter abbreviated as “GPC”)) is formed, and a thermoplastic polyurethane urea resin containing such a sparingly-fusible material has very poor melt formability. For this reason, development of a thermoplastic polyurethane urea resin having good melt formability is desired.

Furthermore, it is desired in a powdered thermoplastic polyurethane urea resin used in slush molding and the like that good melt formability can be developed even at relatively low temperature (further improvement of melt formability) and a molding obtained has further improved mechanical properties.

In the process in which after a part of isocyanate groups of the isocyanate-terminated prepolymer is reacted with a low molecular polyol or the like, the remainder of the isocyanate groups is reacted with water, there is the problem that it is difficult to control a molecular weight of a resin by controlling a molar ratio between an isocyanate group and an active hydrogen group (molecular weight design process conventionally used frequently). This is due to that a part of water evaporates or is supplied to a side reaction during the reaction and a given amount (equivalent amount of the remainder of isocyanate group) of an active hydrogen group cannot surely be reacted with the remainder of isocyanate groups.

On the other hand, in a molding of a thermoplastic resin, blooming phenomenon may be generated with time. The blooming phenomenon greatly reduces the commercial value of a molding, and it is therefore required for the molding that the blooming phenomenon with time is not generated (blooming resistance).

A first object of the present invention is to provide a process that can securely produce a powdered thermoplastic polyurethane urea resin which can obtain a molding having excellent mechanical properties, abrasion resistance and crease resistance, can easily control a molecular weight, and has excellent melt formability.

A second object of the invention is to provide a process that can securely produce a powdered thermoplastic polyurethane urea resin having particularly excellent melt formability such that even where the resin is molded at low temperature at which defective melting has been generated in resins obtained by the conventional processes, defective melting is not generated in a molding obtained.

A third object of the invention to provide a process that can securely produce a powdered thermoplastic polyurethane urea resin which can obtain a molding having excellent mechanical properties even though molded at low temperature.

A fourth object of the invention to provide a process that can securely produce a powdered thermoplastic polyurethane urea resin which can obtain a molding having excellent blooming resistance.

A fifth object of the invention to provide a process that can securely produce a powdered thermoplastic polyurethane urea resin which is suitable as a powder material for slush molding.

### Means for Solving the Problems

(1) The production process of the present invention (first invention) is a process for producing a powdered thermoplastic polyurethane urea resin, including a step of forming a polyurethane urea resin by subjecting

an isocyanate-terminated prepolymer (I) obtained by reacting a polymer polyol (a), an organic polyisocyanate (b) and a monofunctional active hydrogen-containing compound (c) having an active hydrogen group and a hydrocarbon group having from 4 to 12 carbon atoms, and

water (e)

to chain extension reaction in a non-aqueous dispersion medium,

wherein when the mole number of an active hydrogen group of the polymer polyol (a) subjected to the reaction is A, the mole number of the active hydrogen group of the monofunctional active hydrogen-containing compound (c) is x1, and the mole number of an active hydrogen group of water (e) is x3, the conditions shown by the following formulae (1) and (2) are satisfied.

0.3≦(x1+x3)/A≦0.5 Formula (1)

5/95≦x1/x3≦35/65 Formula (2)

(2) It is preferred that the first invention includes the following first to fourth steps, and the monofunctional active hydrogen-containing compound (c) having an active hydrogen group and a hydrocarbon group having from 4 to 12 carbon atoms is reacted in the second step and/or as a pre-step of the third step.

First step: A step of dispersing the polymer polyol (a) in the non-aqueous dispersion medium to prepare a dispersion.

Second step: A step of adding the organic polyisocyanate (b) to the dispersion obtained by the first step and reacting the polymer polyol (a) and the organic polyisocyanate (b) to prepare a dispersion of the isocyanate-terminated prepolymer.

Third step: A step of adding water to the dispersion obtained by the second step or through a pre-step of the third step, subjecting the isocyanate-terminated prepolymer (I) and water (e) to chain extension reaction in the non-aqueous dispersion medium to form a polyurethane urea resin, and preparing its dispersion.

Fourth step: A step of separating and drying the polyurethane urea resin from the dispersion obtained by the third step to prepare a powdered thermoplastic polyurethane urea resin.

(3) It is preferred that the polymer polyol (a), the organic polyisocyanate (b) and the monofunctional active hydrogen-containing compound (c) are reacted in the second step.

(4) It is preferred that the monofunctional active hydrogen-containing compound (c) is added to the dispersion obtained by the second step to react the isocyanate-terminated prepolymer and the monofunctional active hydrogen-containing compound (c), as the pre-step of the third step.

(5) It is preferred that in the (4) above, the ratio ((x1+x3)/A) is from 0.3 to 1.2, and the ratio (x1/x3) is (5 to 20)/(95 to 80).

(6) It is preferred that in the (4) above, the ratio ((x1+x3)/A) is from 0.75 to 1.5, and the ratio (x1/x3) is (10 to 35)/(90 to 65).

(7) It is preferred that the organic polyisocyanate (b) is hexamethylene diisocyanate.

(8) It is preferred that the monofunctional active hydrogen-containing compound (c) is a dialkyl amine.

(9) It is preferred that the monofunctional active hydrogen-containing compound (c) is a monool.

(10) It is preferred to produce a powdered thermoplastic polyurethane urea resin for slush molding.

(11) The production process of the invention (second invention) is a process for producing a powdered thermoplastic polyurethane urea resin, comprising a step of forming a polyurethane urea resin by subjecting

an isocyanate-terminated prepolymer (II) obtained by reacting a polymer polyol (a), an organic polyisocyanate (b), a monofunctional active hydrogen-containing compound (c) having an active hydrogen group and a hydrocarbon group having from 4 to 12 carbon atoms, and a bifunctional active hydrogen-containing compound (d) having a number average molecular weight of less than 500, and

water (e)

to chain extension reaction in a non-aqueous dispersion medium,

wherein when the mole number of an active hydrogen group of the polymer polyol (a) subjected to the reaction is A, the mole number of the active hydrogen group of the monofunctional active hydrogen-containing compound (c) is x1, the mole number of an active hydrogen group of the bifunctional active hydrogen-containing compound (d) is x2, and the mole number of an active hydrogen group of water (e) is x3, the conditions shown by the following formulae (1) to (3) are satisfied.

0.3≦(x1+x2+x3)/A≦1.5 Formula (1)

5/95≦x1/(x2+x3)≦25/75 Formula (2)

3/97≦x2/x3≦67/33 Formula (3)

(12) It is preferred that the second invention includes the following first to fourth steps, and the monofunctional active hydrogen-containing compound (c) having an active hydrogen group and a hydrocarbon group having from 4 to 12 carbon atoms is reacted in the second step and/or as a pre-step of the third step, and additionally, the bifunctional active hydrogen-containing compound (d) having a number average molecular weight of less than 500 is reacted in the second step and/or as a pre-step of the third step.

First step: A step of dispersing the polymer polyol (a) in a non-aqueous dispersion medium to prepare a dispersion.

Second step: A step of adding the organic polyisocyanate (b) to the dispersion obtained by the first step and reacting the polymer polyol (a) and the organic polyisocyanate (b) to prepare a dispersion of the isocyanate-terminated prepolymer.

Third step: A step of adding water to the dispersion obtained by the second step or through a pre-step of the third step, subjecting the isocyanate-terminated prepolymer (II) and water (e) to chain extension reaction in the non-aqueous dispersion medium to form a polyurethane urea resin, and preparing its dispersion.

Fourth step: A step of separating and drying the polyurethane urea resin from the dispersion obtained by the third step to prepare a powdered thermoplastic polyurethane urea resin.

(13) It is preferred that in the second step, the polymer polyol (a), the organic polyisocyanate (b) and the monofunctional active hydrogen-containing compound (c) are reacted to prepare a dispersion of the isocyanate-terminated prepolymer, and as the pre-step of the third step, the bifunctional active hydrogen-containing compound (d) is added to the dispersion obtained in the second step to react the isocyanate-terminated prepolymer and the bifunctional active hydrogen-containing compound (d).

(14) It is preferred that the polymer polyol (a), the organic polyisocyanate (b), the monofunctional active hydrogen-containing compound (c) and the bifunctional active hydrogen-containing compound (d) are reacted in the second step.

(15) It is preferred that in the second step, the polymer polyol (a), the organic polyisocyanate (b) and the bifunctional active hydrogen-containing compound (d) are reacted to prepare a dispersion of the isocyanate-terminated prepolymer, and as the pre-step of the third step, the monofunctional active hydrogen-containing compound (c) is added to the dispersion obtained by the second step to react the isocyanate-terminated prepolymer and the monofunctional active hydrogen-containing compound (c).

(16) It is preferred that as the pre-step of the third step, the monofunctional active hydrogen-containing compound (c) and the bifunctional active hydrogen-containing compound (d) are added to the dispersion obtained by the second step to react the isocyanate-terminated prepolymer, the monofunctional active hydrogen-containing compound (c) and the bifunctional active hydrogen-containing compound (d).

(17) It is preferred that the organic polyisocyanate (b) is hexamethylene diisocyanate.

(18) It is preferred to produce a powdered thermoplastic polyurethane urea resin for slush molding.

### ADVANTAGE OF THE INVENTION

According to the production process of the first invention, the following advantages are exhibited.

(1) By using the mono functional active hydrogen-containing compound (c) in a specific proportion, it is easy to control a molecular weight, and formation of a sparingly fusible material having an excessively large molecular weight (for example, Mn is 500,000 or more in GPC analysis) is restrained. As a result, melt formability of the powdered thermoplastic polyurethane urea resin obtained is markedly improved.
(2) By subjecting the isocyanate-terminated prepolymer (I) and water (e) to chain extension reaction, a urea group is introduced into the resin obtained. As a result, excellent crease resistance, mechanical properties and abrasion resistance are developed in a molding by the powdered thermoplastic polyurethane urea resin obtained.
(3) Due to that the hydrocarbon group of the monofunctional active hydrogen-containing compound (c) has from 4 to 12 carbon atoms, the molecular weight of the powdered thermoplastic polyurethane urea resin obtained can surely be controlled, and additionally, a molding by the powdered thermoplastic polyurethane urea resin has excellent blooming resistance.

According to the production process of the second invention, the following advantages are exhibited.

(1) By using the mono functional active hydrogen-containing compound (c) in a specific proportion, it is easy to control a molecular weight, and formation of a sparingly fusible material having an excessively large molecular weight (for example, Mn is 500,000 or more in GPC analysis) is restrained. As a result, melt formability of the powdered thermoplastic polyurethane urea resin obtained is markedly improved.
(2) By concurrently using the bifunctional active hydrogen-containing compound (d) in a specific proportion, particularly excellent melt formability can be imparted to the resin obtained, and the lower limit of the formable temperature of the resin can sufficiently be lowered. As a result, even where the resin obtained by the production process of the invention is molded at low temperature (temperature at which defective melting has been generated in resins obtained by the conventional processes), defective melting is not generated in a molding obtained. Additionally, the molding obtained has excellent mechanical properties.
(3) By subjecting the isocyanate-terminated prepolymer (II) and water (e) to chain extension reaction, a urea group together with a urethane bond are introduced into the resin obtained. As a result, excellent crease resistance, mechanical properties and abrasion resistance are developed in a molding by the powdered thermoplastic polyurethane urea resin obtained.
(4) Due to that the hydrocarbon group of the monofunctional active hydrogen-containing compound (c) has from 4 to 12 carbon atoms, the molecular weight of the powdered thermoplastic polyurethane urea resin obtained can surely be controlled, and additionally, a molding by the powdered thermoplastic polyurethane urea resin has excellent blooming resistance.

### BEST MODE FOR CARRYING OUT THE INVENTION

### First Invention

The production process according to the first invention includes a step of forming a polyurethane urea resin by subjecting an isocyanate-terminated prepolymer (isocyanate-terminated prepolymer (I)) obtained by reacting a polymer polyol (a), an organic polyisocyanate (b) and a monofunctional active hydrogen-containing compound (c) in specific proportions, and water (e) to chain extension reaction in a non-aqueous dispersion medium.

Specifically, in the first invention, the polymer polyol (a), the organic polyisocyanate (b) and the monofunctional active hydrogen-containing compound (c) are reacted in specific proportions to form the isocyanate-terminated prepolymer (I), and the isocyanate-terminated prepolymer (I) is chain-extended with water (e) in a non-aqueous dispersion medium.

Unless otherwise indicated, the term “isocyanate-terminated prepolymer” in the first invention means all of prepolymers in the stage before the chain extension reaction with water (e) is conducted, and specifically includes the isocyanate-terminated prepolymer (I), and further includes prepolymers obtained by reacting the polymer polyol (a) and the organic polyisocyanate (b).

The polymer polyol (a) used to obtain the isocyanate-terminated prepolymer (I) has a number average molecular weight of 500 or more, and preferably from 1,000 to 5,000.

The kind of the polymer polyol (a) is not particularly limited, and examples thereof include polyester polyol, polyester amide polyol, polyether polyol, polyether-ester polyol, polycarbonate polyol and polyolefin polyol. Those can be used alone or as mixtures of two or more thereof.

The “polyester polyol” and “polyester amide polyol” used as the polymer polyol (a) are obtained by the reaction between a polycarboxylic acid or polycarboxylic acid derivatives such as an dialkyl ester, an acid anhydride or an acid halide of a polycarboxylic acid, and a low molecular active hydrogen-containing compound such as a low molecular polyol, a low molecular polyamine having a number average molecular weight of less than 500 or a low molecular aminoalcohol having a number average molecular weight of less than 500.

Examples of the polycarboxylic acid include succinic acid, adipic acid, sebacic acid, azelaic acid, terephthalic acid, isophthalic acid, orthophthalic acid, hexahydroterephthalic acid and hexahydroisophthalic acid.

Examples of the low molecular polyol include ethylene glycol, 1,3-propylene glycol, 1,2-propylene glycol, 1,2-butanediol, 1,3-butanediol, 1,4-butanediol (hereinafter abbreviated as “1,4-BD”), 1,5-pentanediol, 1,6-hexanediol (hereinafter abbreviated as “1,6-HD”), 2-methyl-1,3-propanediol, 3-methyl-1,5-pentanediol, neopentyl glycol, 1,8-octanediol, 1,9-nonanediol, 3,3-dimethylol heptane, diethylene glycol, 1,4-cyclohexanediol, 1,4-cyclohexane dimethanol, 2-ethyl-1,3-propanediol, 2-normal propyl-1,3-propanediol, 2-isopropyl-1,3-propanediol, 2-normal butyl-1,3-propanediol, 2-isobutyl-1,3-propanediol, 2-tertiary butyl-1,3-propanediol, 2-methyl-2-ethyl-1,3-propanediol, 2,2-diethyl-1,3-propanediol, 2-ethyl-2-normal propyl-1,3-propanediol, 2-ethyl-2-normal butyl-1,3-propanediol, 2-ethyl-3-ethyl-1,4-butanediol, 2-methyl-3-ethyl-1,4-butanediol, 2,3-diethyl-1,5-pentanediol, 2,4-diethyl-1,5-pentanediol, 2,3,4-triethyl-1,5-pentanediol, trimethylolpropane, diemthylolpropionic acid, dimethylolbutanic acid, dimer acid diol, glycerin, pentaerythritol, and an alkylene oxide adduct of bisphenol A.

Examples of the low molecular polyamine having a number average molecular weight of less than 500 include ethylenediamine, hexamethylenediamine, xylilenediamine, isophorone diamine and ethylene triamine.

Examples of the low molecular aminoalcohol having a number average molecular weight of less than 500 include monoethanol amine, diethanol amine and monopropanol amine.

Furthermore, a polyester polyol such as a lactone-based polyester polyol obtained by ring-opening polymerization of a cyclic ester (lactone) monomer such as ε-caprolactone, an alkyl-substituted ε-caprolactone, ε-valerolactone or an alkyl-substituted ε-valerolactone can also suitably be used.

Examples of the “polyether polyol” used as the polymer polyol (a) include a polyethylene glycol, a polypropylene ether polyol and a polytetramethylene ether polyol.

Examples of the “polyether-ester polyol” used as the polymer polyol (a) include polyester polyols produced from the above-described polyether polyols and the above-described polycarboxylic acid derivatives.

Examples of the “polycarbonate polyol” used as the polymer polyol (a) include products obtained by deethanol condensation reaction between a low molecular polyol and diethyl carbonate; dephenol condensation reaction between a low molecular polyol and diphenyl carbonate; and deethylene glycol condensation reaction between a low molecular polyol and ethylene carbonate. Examples of the low molecular polyol used to obtain the polycarbonate polyol include low molecular polyols illustrated as polyols for obtaining a polyester polyol.

Specific examples of the “polyolefin polyol” used as the polymer polyol (a) include a hydroxyl-terminated polybutadiene or its hydrogenated product, and a hydroxyl-containing chlorinated polyolefin.

The preferred polymer polyol (a) is a polyester polyol, a polyether polyol or a polycarbonate polyol, each having a number average molecular weight of from 1,000 to 5,000, from the point that a molding obtained can develop good physical properties and feeling. Above all, a polyester polyol having a number average molecular weight of from 1,000 to 5,000 is preferred, and a polyester polyol using 50 mol % or more of an aromatic dicarboxylic acid as an acid component is particularly preferred.

Examples of the organic polyisocyanate (b) used to obtain the isocyanate-terminated prepolymer (I) include aromatic diisocyanates such as 2,4-tolylene diisocyanate, 2,6-tolylene diisocyanate, xylene-1,4-diisocyanate, xylene-1,3-diisocyanate, tetramethylxylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate and 3,3′-dimethoxydiphenyl-4,4′-diisocyanate; aliphatic diisocyanates such as tetramethylene diisocyanate, hexamethylene diisocyanate (hereinafter abbreviated as “HDI”), decamethylene diisocyanate and lysine diisocyanate; alicyclic diisocyanates such as isophorone diisocyanate, hydrogenated tolylene diisocyanate, hydrogenated xylene diisocyanate, hydrogenated diphenylmethane diisocyanate and hydrogenated tetramethylxylene diisocyanate; their polymers, polymeric products, urethane-modified products, arophanate-modified products, urea-modified products, burette-modified products, carbodiimide-modified products, uretone imine-modified products, uretodione-modified products and isocyanurate-modified products; and mixtures of two or more thereof. Of those, considering weathering resistance of a molding, aliphatic and alicyclic diisocyanates are preferred, HDI, isophorone diisocyanate and hydrogenated diphenylmethane diisocyanate are particularly preferred, and HDI is most preferred.

The monofunctional active hydrogen-containing compound (c) used to obtain the isocyanate-terminated prepolymer (I) is a mono functional active hydrogen-containing compound having an active hydrogen group and a hydrocarbon group having from 4 to 12 carbon atoms.

Examples of the “active hydrogen group” of the monofunctional active hydrogen-containing compound (c) include a hydroxyl group (—OH), an imino group (═NH) and an amino group (—NH₂).

Examples of the “hydrocarbon group having from 4 to 12 carbon atoms” in the monofunctional active hydrogen-containing compound (c) include an alkyl group and an alkenyl group.

The carbon atom number of the “hydrocarbon group” in monofunctional active hydrogen-containing compound (c) is from 4 to 12, preferably from 4 to 11, and more preferably from 4 to 9.

Where an active hydrogen-containing compound having less than 4 carbon atoms is used, the molecular weight of a resin obtained cannot be controlled (see Comparative Example 1-7 described hereinafter). On the other hand, where an active hydrogen-containing compound having carbon atoms exceeding 12 is used, blooming is generated in a molding by the resin obtained (see Comparative Examples 1-4 to 1-6 described hereinafter).

Specific examples of the monofunctional active hydrogen-containing compound (c) include dialkyl amines (secondary amines) such as di-n-butylamine, di-isobutylamine, di-t-butylamine, di-n-hexylamine, di-cyclohexylamine, di-n-octylamine, di-2-ethylhexylamine, di-n-nonylamine and di-dodecylamine; dialkenyl amines such as di-allylamine; alkyl amines (primary amines) such as dodecylamine; and monools such as n-butanol, isobutanol, n-octanol, 2-ethylhexanol, n-nonynol, n-decanol, lauryl alcohol and cyclohexanol. Those can be used alone or as mixtures of two or more thereof. Of those, dialkylamines and monools are preferred, and dialkylamines are particularly preferred.

Where the monofunctional active hydrogen-containing compound (c) is not used, formation of a sparingly fusible material having an excessively large molecular weight cannot be restrained, and a polyurethane urea resin obtained is very poor in melt formability (leveling property and pinhole-preventive performance). Additionally, a molding obtained does not have sufficient mechanical properties (see Comparative Examples I-1 to 1-2 described hereinafter).

In the production process according to the first invention, water is used as a chain extender of the isocyanate-terminated prepolymer (I).

A polyurethane urea resin is formed by the reaction (chain extension reaction) between the isocyanate-terminated prepolymer (I) and water (e).

The reaction between the isocyanate-terminated prepolymer (I) and water (e) is conducted in a non-aqueous dispersion medium.

The non-aqueous dispersion medium comprises the polymer polyol (a) and an organic solvent which does not substantially dissolve the isocyanate-terminated prepolymer (I) obtained and the polyurethane urea resin obtained.

Where the polymer polyol (a) comprises a compound having polarity such as a polyester polyol, a polyether polyol or a polycarbonate polyol, as the main component, examples of the organic solvent that can be used as the non-aqueous dispersion medium include aliphatic organic media such as pentane, hexane, heptane, octane, dodecane or a paraffinic solvent; alicyclic organic media such as cyclopentane, cyclohexane or methyl cyclohexane; and non-polar and/or low polar organic media such as an organic medium used as a plasticizer, such as dioctyl phthalate. Where the polymer polyol (a) comprises a non-polar compound such as a hydroxyl-containing polybutadine or a hydroxyl-containing hydrogenated polybutadiene, as the main component, examples of the organic solvent include polar organic media such as acetone or methyl ethyl ketone.

It is preferred to use a dispersing agent from the standpoint that the polymer polyol (a) is uniformly dispersed in the non-aqueous dispersion medium. Dispersing agents described in, for example, JP-A-2004-161866 can preferably be used as the dispersing agent.

In the production process according to the first invention, when the mole number of an active hydrogen group in the polymer polyol (a) subjected to the reaction is A, the mole number of an active hydrogen group in the monofunctional active hydrogen-containing compound (c) subjected to the reaction is x1, and the mole number of an active hydrogen group in water (e) subjected to the reaction is x3, the ratio ((x1+x3)/A) is from 0.3 to 1.5.

Where the ratio ((x1+x3)/A) is less than 0.3, a urea group in a sufficient concentration cannot be introduced into the polyurethane urea resin obtained, and excellent crease resistance, mechanical properties and abrasion resistance cannot be imparted to a molding by the resin.

On the other hand, where the ratio ((x1+x3)/A) exceeds 1.5, the concentration of a urea group in the polyurethane urea resin obtained is excessive, and formation of a sparingly fusible material by a side reaction cannot be restrained, resulting in deterioration of melt formability.

In the production process according to the first invention, the ratio (x1/x3) is from 5/95 to 35/65.

Where the ratio (x1/x3) is less than 5/95, that is, the proportion of the monofunctional active hydrogen-containing compound (c) is excessively small, formation of a sparingly fusible material having an excessively large molecular weight cannot be restrained, and a polyurethane urea resin obtained cannot develop preferred melt formability (particularly, leveling property and pinhole-preventive performance) (see Comparative Examples I-8 and I-10 described hereinafter).

On the other hand, where the ratio (x1/x3) exceeds 35/65, that is, the proportion of the monofunctional active hydrogen-containing compound (c) is excessively large, good crease resistance, abrasion resistance and the like cannot be imparted to a molding by the polyurethane urea resin obtained (see Comparative Example 1-9 and Comparative Examples I-11 to I-13 described hereinafter).

The production process according to the first invention includes the first step (dispersion step of the polymer polyol (a)), the second step (formation step of the isocyanate-terminated prepolymer), the third step (formation step of the polyurethane urea resin) and the fourth step (preparation step of the powdered thermoplastic polyurethane urea resin) as described above. It is preferred that the monofunctional active hydrogen-containing compound (c) is reacted in the second step and/or as a pre-step of the third step.

The first step is a step of dispersing the polymer polyol (a) in an organic solvent (non-aqueous dispersion medium) which does not substantially dissolve the polymer polyol (a), the isocyanate-terminated prepolymer (I) obtained and the polyurethane urea resin, thereby preparing a dispersion.

It is preferred to use a dispersing agent (dispersing agents described in, for example, JP-A-2004-161866) in the first step. The amount of the dispersing agent used is preferably from 0.1 to 10% by mass, and more preferably from 0.5 to 5% by mass, based on the polymer polyol.

In the dispersion of the polymer polyol (a) obtained in the first step, the mass ratio of a dispersing phase (total amount of raw materials other than dispersion medium) and a continuous phase (dispersion medium) is preferably dispersing phase/continuous phase=10/90 to 80/20, and more preferably 40/60 to 80/20, considering production efficiency and production cost.

The second step is a step of reacting the organic polyisocyanate (b) with the polymer polyol (a) in the dispersion obtained in the first step, thereby preparing a dispersion of the isocyanate-terminated prepolymer.

Specifically, the organic polyisocyanate (b) is added to the dispersion of the polymer polyol (a) obtained in the first step, and the system is heated to conduct urethanation reaction.

In the second step, the proportion of the polymer polyol (a) and the organic polyisocyanate (b) is that the molar ratio of the isocyanate group in the latter to the hydroxyl group in the former (NCO/OH) is preferably from 1.05 to 5.0, and more preferably from 1.3 to 2.5.

Where the molar ratio (NCO/OH) is less than 1.05, NCO group in a sufficient concentration cannot be introduced into the isocyanate-terminated prepolymer obtained, a urea group in a sufficient concentration cannot be introduced into the polyurethane urea resin obtained using the same, and excellent crease resistance, mechanical properties and abrasion resistance cannot be imparted to a molding by the resin.

On the other hand, where the molar ratio (NCO/HO) exceeds 5.0, excess amount of NCO group is introduced into the isocyanate-terminated prepolymer obtained, concentration of a urea group in the polyurethane urea resin obtained using the same is excessive, and formation of a sparingly fusible material by a side reaction cannot be restrained, resulting in deterioration of melt formability.

According to need, the conventional urethanation catalyst or the like can be used in the second step. Examples of the urethanation catalyst include triethylenediamine, bis-2-dimethylaminoethyl ether, dibutyltinlaurate, lead naphthenate, iron naphthenate, copper octenate and bismuth catalyst.

In the second step of the production process according to the first invention, the monofunctional active hydrogen-containing compound (c) is reacted with the organic polyisocyanate (b), according to need (where a pre-step of the third step is not conducted, this reaction is essential) (see Example 1-16 described hereinafter). By this, the isocyanate-terminated prepolymer (I) by the polymer polyol (a), the organic polyisocyanate (b) and the monofunctional active hydrogen-containing compound (c) is obtained.

The timing that the monofunctional active hydrogen-containing compound (c) is introduced into the dispersion is not particularly limited so long as it is before the formation of the isocyanate-terminated prepolymer by the polymer polyol (a) and the organic polyisocyanate (b) (before completion of the second step). The monofunctional active hydrogen-containing compound (c) may be charged together with the polymer polyol (a) in the first step.

The reaction conditions in the second step vary depending on the kind (boiling point) of the dispersion medium, or the like, but are preferably a reaction temperature of from 40 to 110° C. an a reaction time of from 1 to 4 hours, and more preferably a reaction temperature of from 50 to 100° C. and a reaction time of from 2 to 3 hours.

In the production process according to the first invention, the monofunctional active hydrogen-containing compound (c) is reacted with the isocyanate-terminated prepolymer obtained in the second step, as a pre-step of the third step according to need (where the monofunctional active hydrogen-containing compound (c) is not used in the second step, this reaction is essential) (see Examples I-1 to 1-15 described hereinafter). By this, the isocyanate-terminated prepolymer (I) by the polymer polyol (a), the organic polyisocyanate (b) and the monofunctional active hydrogen-containing compound (c) is obtained.

The timing that the monofunctional active hydrogen-containing compound (c) is introduced into the dispersion is not particularly limited so long as it is after completion of the second step and before initiation (addition of water) of the third step.

The reaction temperature between the isocyanate-terminated prepolymer and the monofunctional active hydrogen-containing compound (c) is preferably from 40 to 85° C., and more preferably from 50 to 80° C.

The third step is a step of adding water to the dispersion obtained by the second step or through a pre-step of the third step, subjecting the isocyanate-terminated prepolymer (I) and water (e) to chain extension reaction until the isocyanate group is completely consumed in a non-aqueous dispersion medium to form the polyurethane urea resin, and preparing its dispersion.

Specifically, water is added to the dispersion of the isocyanate-terminated prepolymer (I) obtained by the second step or through a pre-step of the third step, and an isocyanate group in the isocyanate-terminated prepolymer (I) and an active hydrogen group in water are reacted until the isocyanate group is completely consumed.

The amount of water added is an amount excess to the isocyanate group in the isocyanate-terminated prepolymer (I). Specifically, considering loss due to evaporation of water or the like, the amount is preferably from 2 to 100 equivalents, and more preferably from 3 to 20 equivalents, of the isocyanate group. Where the amount of water added is less, the isocyanate group cannot completely be consumed (ureation). As a result, mechanical properties of a molding formed from the polyurethane urea resin obtained may deteriorate, and change in properties with time may be generated in the molding due to the residual isocyanate group in the resin.

The reaction temperature in the reaction between the isocyanate-terminated prepolymer (I) and water (e) is preferably from 40 to 85° C., and more preferably from 50 to 80° C.

Where the reaction temperature is too low, the reaction requires much time. On the other hand, where the reaction temperature is too high, water or the like evaporates, and it is difficult to control a molecular weight.

The conventional surfactant may be used in the third step.

In the production process according to the first invention, when the mole number of an active hydrogen group of the polymer polyol (a) subjected to the reaction is A, the mole number of an active hydrogen group of the monofunctional active hydrogen-containing compound (c) subjected to the reaction is x1, and the mole number of an active hydrogen group of water (e) subjected to the reaction is x3, the ratio ((x1+x3)/A) is from 0.3 to 1.5, and the ratio (x1/x3) is from 5/95 to 35/65.

Furthermore, in the production process according to the first invention, it is preferred that:

(1) the ratio ((x1+x3)/A) is from 0.3 to 1.2, and the ratio (x1/x3) is (5 to 20)/(95 to 80), and

(2) particularly, the ratio ((x1+x3)/A) is from 0.75 to 1.5, and the ratio (x1/x3) is (10 to 35)/(90 to 65).

The fourth step is a step of separating and drying the polyurethane urea resin from the dispersion obtained in the third step to prepare a powdered thermoplastic polyurethane urea resin.

Specifically, the polyurethane urea resin is separated from the dispersion medium by a filtration method or a decantation method, and is then dried at ordinary temperature or under heating at ordinary pressures or under reduced pressure.

The preferred production process according to the first invention is described below.

(1) A process for producing a powdered thermoplastic polyurethane urea resin by:

reacting the polymer polyol (a), the organic polyisocyanate (b) and the monofunctional active hydrogen-containing compound (c) to prepare a dispersion of the isocyanate-terminated prepolymer (I) in the second step (formation step of isocyanate-terminated prepolymer);

adding water to the dispersion obtained in the second step, subjecting the isocyanate-terminated prepolymer (I) and water (e) to chain extension reaction to form the polyurethane urea resin, and preparing its dispersion in the third step (formation step of polyurethane urea resin); and

separating and drying the polyurethane urea resin from the dispersion obtained in the third step in the fourth step (preparation step of powdered thermoplastic polyurethane urea resin).

(2) A process for producing a powdered thermoplastic polyurethane urea resin by:

reacting the polymer polyol (a) and the organic polyisocyanate (b) to prepare a dispersion of the isocyanate-terminated prepolymer (I), in the second step (formation step of isocyanate-terminated prepolymer);

adding the monofunctional active hydrogen-containing compound (c) to the dispersion obtained in the second step, reacting the isocyanate-terminated prepolymer and the monofunctional active hydrogen-containing compound (c) to form the isocyanate-terminated prepolymer (I), and preparing its dispersion, as a pre-step of the third step;

adding water to the dispersion obtained in the pre-step, subjecting the isocyanate-terminated prepolymer (I) and water (e) to chain extension reaction to form the polyurethane urea resin, and preparing its dispersion, in the third step (formation step of polyurethane urea resin); and

separating and drying the polyurethane urea resin from the dispersion obtained in the third step, in the fourth step (preparation step of powdered thermoplastic polyurethane urea resin).

### Second Invention

The production process according to the second invention includes a step of forming a polyurethane urea resin by subjecting an isocyanate-terminated prepolymer (isocyanate-terminated prepolymer (II)) obtained by reacting the polymer polyol (a), the organic polyisocyanate (b), the monofunctional active hydrogen-containing compound (c) and a bifunctional active hydrogen-containing compound (d) in specific proportions, and water (e) to chain extension reaction in a non-aqueous dispersion medium.

Specifically, in the second invention, the polymer polyol (a), the organic polyisocyanate (b), the monofunctional active hydrogen-containing compound (c) and the bifunctional active hydrogen-containing compound (d) are reacted in specific proportions to form the isocyanate-terminated prepolymer (II), and the isocyanate-terminated prepolymer (II) is chain-extended with water (e) in a non-aqueous dispersion medium.

Unless otherwise indicated, the “isocyanate-terminated prepolymer” in the second invention means all of prepolymers in the stage before the chain extension reaction with water (e), and specifically includes the isocyanate-terminated prepolymer (II), and further includes:

(i) prepolymers obtained by reacting the polymer polyol (a) and the organic polyisocyanate (b);

(ii) prepolymers obtained by reacting the polymer polyol (a), and the organic polyisocyanate (b) and the monofunctional active hydrogen-containing compound (c) (the isocyanate-terminated prepolymer (I) according to the first invention); and

(iii) prepolymers obtained by reacting the polymer polyol (a), and the organic polyisocyanate (b) and the bifunctional active hydrogen-containing compound (d).

The polymer polyol (a) used to obtain the isocyanate-terminated prepolymer (II) has a number average molecular weight of 500 or more, and preferably from 1,000 to 5,000.

Examples of the polymer polyol (a) used to obtain the isocyanate-terminated prepolymer (II) include the compounds illustrated as the polymer polyol (a) used to obtain the isocyanate-terminated prepolymer (I) according to the first invention (polyester polyol, polyester amide polyol, polyether polyol, polyether-ester polyol, polycarbonate polyol, polyolefin polyol and the like). Those can be used alone or as mixtures of two or more thereof.

The preferred polymer polyol (a) is a polyester polyol, a polyether polyol or a polycarbonate polyol, each having a number average molecular weight of from 1,000 to 5,000, from the point that a molding obtained can develop good physical properties and feeling. Above all, a polyester polyol having a number average molecular weight of from 1,000 to 5,000 is preferred, and a polyester polyol using 50 mol % or more of an aromatic dicarboxylic acid as an acid component is particularly preferred.

Examples of the organic polyisocyanate (b) used to obtain the isocyanate-terminated prepolymer (II) include the compounds illustrated as the organic polyisocyanate (b) used to obtain the isocyanate-terminated prepolymer (I) according to the first invention (aromatic diisocyanates, aliphatic diisocyanates, alicyclic diisocyanates, polymers of diisocyanates, and various derivatives or modified products). Those can be used alone or as mixtures of two or more thereof. Of those, considering weathering resistance or the like of a molding, aliphatic and alicyclic diisocyanates are preferred, HDI, isophorone diisocyanate and hydrogenated diphenylmethane diisocyanate are particularly preferred, and HDI is most preferred.

The monofunctional active hydrogen-containing compound (c) used to obtain the isocyanate-terminated prepolymer (II) is a mono functional active hydrogen-containing compound having an active hydrogen group and a hydrocarbon group having from 4 to 12 carbon atoms.

Examples of the active hydrogen group in the monofunctional active hydrogen-containing compound (c) include a hydroxyl group (—OH), an imino group (═NH) and an amino group (—NH₂).

Examples of the hydrocarbon group having from 4 to 12 carbon atoms in the monofunctional active hydrogen-containing compound (c) include an alkyl group and an alkenyl group.

The carbon atom number of the hydrocarbon group in monofunctional active hydrogen-containing compound (c) is from 4 to 12, preferably from 4 to 11, and more preferably from 4 to 9.

Where an active hydrogen-containing compound having carbon atoms of less than 4 is used, the molecular weight of a resin obtained cannot be controlled (see Comparative Example II-11 described hereinafter). On the other hand, where an active hydrogen-containing compound having carbon atoms exceeding 12 is used, blooming is generated in a molding by the resin obtained (see Comparative Examples II-10 and II-12 described hereinafter).

Specific examples of the monofunctional active hydrogen-containing compound (c) include dialkyl amines (secondary amines) such as di-n-butylamine, di-isobutylamine, di-t-butylamine, di-n-hexylamine, di-cyclohexylamine, di-n-octylamine, di-2-ethylhexylamine, di-n-nonylamine and di-dodecylamine; dialkenyl amines such as di-allylamine; alkyl amines (primary amines) such as dodecylamine; and monools such as n-butanol, isobutanol, n-octanol, 2-ethylhexanol, n-nonynol, n-decanol, lauryl alcohol and cyclohexanol. Those can be used alone or as mixtures of two or more thereof. Of those, dialkylamines and monools are preferred, and dialkylamines are particularly preferred.

Where the monofunctional active hydrogen-containing compound (c) is not used, formation of a sparingly fusible material having an excessively large molecular weight cannot be restrained, and a polyurethane urea resin obtained is very poor in melt formability (leveling property and pinhole-preventive performance). Additionally, a molding obtained does not have sufficient mechanical properties (see Comparative Examples II-7 to II-9 described hereinafter).

The bifunctional active hydrogen-containing compound (d) used to obtain the isocyanate-terminated prepolymer (II) is a bifunctional active hydrogen-containing compound having a number average molecular weight of less than 500.

Specific examples of the bifunctional active hydrogen-containing compound (d) include the compounds illustrated as the low molecular polyols used to obtain a polyester polyol as the polymer polyol (a). Those can be used alone or as mixtures of two or more thereof. Of those, 1,4-BD and 1,6-HD are preferred.

Where the bifunctional active hydrogen-containing compound (d) is not used, the polyurethane urea resin obtained cannot sufficiently develop melt formability (leveling property and pinhole-preventive performance) at low temperature.

In the production process according to the second invention, water is used as a chain extender of the isocyanate-terminated prepolymer (II).

A polyurethane urea resin is formed by the reaction (chain extension reaction) between the isocyanate-terminated prepolymer (II) and water (e).

The reaction between the isocyanate-terminated prepolymer (II) and water (e) is conducted in a non-aqueous dispersion medium.

The non-aqueous dispersion medium comprises the polymer polyol (a) and an organic solvent which does not substantially dissolve the isocyanate-terminated prepolymer (II) and the polyurethane urea resin.

Where the polymer polyol (a) comprises a compound having polarity such as a polyester polyol, a polyether polyol or a polycarbonate polyol, as the main component, examples of the organic solvent that can be used as the non-aqueous dispersion medium include aliphatic organic media such as pentane, hexane, heptane, octane, dodecane or a paraffinic solvent; alicyclic organic media such as cyclopentane, cyclohexane or methyl cyclohexane; and non-polar and/or low polar organic media such as an organic medium used as a plasticizer, such as dioctyl phthalate. Where the polymer polyol (a) comprises a non-polar compound such as a hydroxyl-containing polybutadiene or a hydroxyl-containing hydrogenated polybutadiene, as the main component, examples of the organic solvent include polar organic media such as acetone or methyl ethyl ketone.

It is preferred to use a dispersing agent from the standpoint that the polymer polyol is uniformly dispersed in the non-aqueous dispersion medium. Dispersing agents described in, for example, JP-A-2004-161866 can suitably be used as the dispersing agent.

In the production process according to the second invention, when the mole number of an active hydrogen group in the polymer polyol (a) subjected to the reaction is A, the mole number of an active hydrogen group in the monofunctional active hydrogen-containing compound (c) subjected to the reaction is x1, the mole number of an active hydrogen group in the bifunctional active hydrogen-containing compound (d) subjected to the reaction is x2 and the mole number of an active hydrogen group in water (e) subjected to the reaction is x3, the ratio ((x1+x2+x3)/A) is from 0.3 to 1.5, and preferably from 0.5 to 1.3.

Where the ratio ((x1+x2+x3)/A) is less than 0.3, excellent crease resistance, abrasion resistance and the like cannot be imparted to a molding by the polyurethane urea resin obtained. Furthermore, the molding is liable to deform due to deficiency of green strength when demolded (see Comparative Example II-1 described hereinafter).

On the other hand, where the ratio ((x1+x2+x3)/A) exceeds 1.5, formation of a sparingly fusible material having an excessively large molecular weight cannot be restrained, melt formability (leveling property and pinhole-preventive performance) cannot sufficiently be developed at low temperature, and the molding obtained does not have sufficient mechanical properties (see Comparative Example II-2 described hereinafter).

In the production process according to the second invention, the ratio (x1/(x2+x3)) is from 5/95 to 25/75, and preferably from 5/95 to 15/85.

Where the ratio (x1/(x2+x3)) is less than 5/95, that is, the proportion of the monofunctional active hydrogen-containing compound (c) is excessively small, formation of a sparingly fusible material having an excessively large molecular weight cannot be restrained, a polyurethane urea resin obtained cannot sufficiently develop melt formability (leveling property and pinhole-preventive performance) at low temperature, and the molding obtained does not have sufficient mechanical properties (see Comparative Example II-3 described hereinafter).

On the other hand, where the ratio (x1/(x2+x3)) exceeds 25/75, that is, the proportion of the monofunctional active hydrogen-containing compound (c) is excessively large, good crease resistance, abrasion resistance and the like cannot be imparted to a molding by the polyurethane urea resin obtained. Furthermore, the molding is liable to deform due to deficiency of green strength when demoled, and additionally does not have sufficient mechanical properties (see Comparative Example II-4 described hereinafter).

Furthermore, the ratio (x2/x3) is from 3/97 to 67/33, and preferably from 3/97 to 50/50.

Where the ratio (x2/x3) is less than 3/97, that is, the proportion of the bifunctional active hydrogen-containing compound (d) is excessively small, formation of a sparingly fusible material having an excessively large molecular weight cannot be restrained, a polyurethane urea resin obtained cannot sufficiently develop melt formability (leveling property and pinhole-preventive performance) at low temperature, and the molding obtained does not have sufficient mechanical properties (see Comparative Example II-5 described hereinafter).

On the other hand, where the ratio (x2/x3) exceeds 67/33, that is, the proportion of the bifunctional active hydrogen-containing compound (d) is excessively large, good crease resistance, abrasion resistance and the like cannot be imparted to a molding by the polyurethane urea resin obtained. Furthermore, the molding is liable to deform due to deficiency of green strength when demoled (see Comparative Example II-6 described hereinafter).

In the production process according to the second invention, the proportion between (polymer polyol (a), monofunctional active hydrogen-containing compound (c) and bifunctional active hydrogen-containing compound (d)) and the organic polyisocyanate (b), that are used for the reaction for forming the isocyanate-terminated prepolymer (II) is preferably that the ratio (y/(A+x1+x2)) of the isocyanate group (the mole number is y) in (b) to the active hydrogen group in (a)+(c)+(d) (mole number=A+x1+x2) is from 1.3 to 2.5.

Where the molar ratio (y/(A+x1+x2)) is less than 1.3, NCO group in a sufficient concentration cannot be introduced into the isocyanate-terminated prepolymer (II) obtained, a urea group in a sufficient concentration cannot be introduced into the polyurethane urea resin obtained using the same, and excellent crease resistance, mechanical properties and abrasion resistance cannot be imparted to a molding by the resin.

On the other hand, where the molar ratio (y/(A+x1+x2)) exceeds 2.5, excessive NCO group is introduced into the isocyanate-terminated prepolymer (II) obtained, the concentration of a urea group in the polyurethane urea resin obtained using the same is excessive, formation of a sparingly fusible material by a side reaction cannot be restrained, and melt formability deteriorates.

The chain extension reaction is conducted by adding water in an amount excess to the isocyanate-terminated prepolymer (II) such that the molar ratio (y/(A+x1+x2)) is substantially 1 (the isocyanate group is completely consumed).

The production process according to the second invention includes the first step (dispersion step of the polymer polyol (a)), the second step (formation step of the isocyanate-terminated prepolymer), the third step (formation step of the polyurethane urea resin) and the fourth step (preparation step of the powdered thermoplastic polyurethane urea resin) as described above. It is preferred that the monofunctional active hydrogen-containing compound (c) is reacted in the second step and/or as a pre-step of the third step, and the bifunctional active hydrogen-containing compound (d) is further reacted in the second step and/or as a pre-step of the third step.

The first step is a step of dispersing the polymer polyol (a) in a non-aqueous dispersion medium, thereby preparing a dispersion.

The non-aqueous dispersion medium comprises the polymer polyol (a) and an organic solvent which does not substantially dissolve the isocyanate-terminated prepolymer (II) obtained and the polyurethane urea resin obtained, and can appropriately be used according to the kind (polarity) of the polymer polyol (a). It is preferred to use a dispersing agent (dispersing agents described in, for example, JP-A-2004-161866) in the first step. The amount of the dispersing agent used is preferably from 0.1 to 10% by mass, and more preferably from 0.5 to 5% by mass, based on the polymer polyol (a).

In the dispersion of the polymer polyol (a) obtained in the first step, the mass ratio of a dispersing phase (total amount of raw materials other than dispersion medium) and a continuous phase (dispersion medium) is preferably dispersing phase/continuous phase=10/90 to 80/20, and more preferably 40/60 to 80/20, considering production efficiency and production cost.

The second step is a step of reacting the organic polyisocyanate (b) with the polymer polyol (a) in the dispersion obtained in the first step to form the isocyanate-terminated prepolymer, and preparing its dispersion.

Specifically, the organic polyisocyanate (b) is added to the dispersion of the polymer polyol (a) obtained in the first step, and the system is heated to conduct urethanation reaction.

According to need, the conventional urethanation catalyst or the like can be used in the second step. Examples of the urethanation catalyst include triethylenediamine, bis-2-dimethylaminoethyl ether, dibutyltin laurate, lead naphthenate, iron naphthenate, copper octenate and bismuth catalyst.

In the second step of the production process according to the second invention, the monofunctional active hydrogen-containing compound (c) and/or the bifunctional active hydrogen-containing compound (d) are/is reacted with the organic polyisocyanate (b), according to need. By this, the isocyanate-terminated prepolymer by the polymer polyol (a), the organic polyisocyanate (b), the monofunctional active hydrogen-containing compound (c) and/or the bifunctional active hydrogen-containing compound (d) is obtained.

The timing that the monofunctional active hydrogen-containing compound (c) and/or the bifunctional active hydrogen-containing compound (d) are/is introduced into the dispersion is not particularly limited so long as it is before the formation of the isocyanate-terminated prepolymer by the polymer polyol (a) and the organic polyisocyanate (b) (before completion of the second step). The monofunctional active hydrogen-containing compound (c) and/or the bifunctional active hydrogen-containing compound (d) may be charged together with the polymer polyol (a) in the first step.

The reaction conditions in the second step vary depending on the kind (boiling point) of the dispersion medium, or the like, but are preferably a reaction temperature of from 40 to 110° C. and a reaction time of from 1 to 4 hours, and more preferably a reaction temperature of from 50 to 100° C. and a reaction time of from 2 to 3 hours.

In the production process according to the second invention, the monofunctional active hydrogen-containing compound (c) and/or the bifunctional active hydrogen-containing compound (d) are/is reacted with the isocyanate-terminated prepolymer obtained in the second step, as a pre-step of the third step according to need. By this, the isocyanate-terminated prepolymer (II) by the polymer polyol (a), the organic polyisocyanate (b), the monofunctional active hydrogen-containing compound (c) and the bifunctional active hydrogen-containing compound (d) is obtained.

The timing that the monofunctional active hydrogen-containing compound (c) and/or the bifunctional active hydrogen-containing compound (d) are/is introduced into the dispersion is not particularly limited so long as it is after completion of the second step and before initiation (addition of water) of the third step.

The reaction temperature between the isocyanate-terminated prepolymer and the monofunctional active hydrogen-containing compound (c) and/or the bifunctional active hydrogen-containing compound (d) is preferably from 40 to 85° C., and more preferably from 50 to 80° C.

The third step is a step of adding water to the dispersion obtained by the second step or through a pre-step of the third step, subjecting the isocyanate-terminated prepolymer (II) and water (e) to chain extension reaction until the isocyanate group is completely consumed in a non-aqueous dispersion medium to form the polyurethane urea resin, and preparing its dispersion.

The amount of water added is an amount excess to the isocyanate group in the isocyanate-terminated prepolymer (II). Specifically, considering loss due to evaporation of water or the like, the amount is preferably from 2 to 100 equivalents, and more preferably from 3 to 20 equivalents, of the isocyanate group. Where the amount of water added is small, the isocyanate group cannot completely be consumed (ureation). As a result, mechanical properties of a molding formed from the polyurethane urea resin obtained may deteriorate, and change in properties with time may be generated in the molding due to the residual isocyanate group in the resin.

The reaction temperature in the reaction between the isocyanate-terminated prepolymer (II) and water (e) is preferably from 40 to 85° C., and more preferably from 50 to 80° C.

Where the reaction temperature is too low, the reaction requires much time. On the other hand, where the reaction temperature is too high, water or the like evaporates, and it is difficult to control a molecular weight.

The conventional surfactant may be used in the third step.

The fourth step is a step of separating and drying the polyurethane urea resin from the dispersion obtained in the third step to prepare a powdered thermoplastic polyurethane urea resin.

Specifically, the polyurethane urea resin is separated from the dispersion medium by a filtration method or a decantation method, and is then dried at ordinary temperature or under heating at ordinary pressures or under reduced pressure.

The preferred production process according to the second invention is described below.

(1) A process for producing a powdered thermoplastic polyurethane urea resin by:

reacting the polymer polyol (a), the organic polyisocyanate (b) and the monofunctional active hydrogen-containing compound (c) to prepare a dispersion of the isocyanate-terminated prepolymer (I), in the second step (formation step of isocyanate-terminated prepolymer);

adding the bifunctional active hydrogen-containing compound (d) to the dispersion obtained in the second step, reacting the isocyanate-terminated prepolymer and the bifunctional active hydrogen-containing compound (d) to form the isocyanate-terminated prepolymer (II), and preparing its dispersion, as a pre-step of the third step;

adding water to the dispersion obtained in the pre-step, subjecting the isocyanate-terminated prepolymer (II) and water (e) to chain extension reaction to form the polyurethane urea resin, and preparing its dispersion, in the third step (formation step of polyurethane urea resin); and

separating and drying the polyurethane urea resin from the dispersion obtained in the third step, in the fourth step (preparation step of powdered thermoplastic polyurethane urea resin).

(2) A process for producing a powdered thermoplastic polyurethane urea resin by:

reacting the polymer polyol (a), the organic polyisocyanate (b), the monofunctional active hydrogen-containing compound (c) and the bifunctional active hydrogen-containing compound (d) to prepare a dispersion of the isocyanate-terminated prepolymer (II), in the second step (formation step of isocyanate-terminated prepolymer);

adding water to the dispersion obtained in the second step, subjecting the isocyanate-terminated prepolymer (II) and water (e) to chain extension reaction to form the polyurethane urea resin, and preparing its dispersion, in the third step (formation step of polyurethane urea resin); and

separating and drying the polyurethane urea resin from the dispersion obtained in the third step, in the fourth step (preparation step of powdered thermoplastic polyurethane urea resin).

(3) A process for producing a powdered thermoplastic polyurethane urea resin by:

reacting the polymer polyol (a), the organic polyisocyanate (b) and the bifunctional active hydrogen-containing compound (d) to prepare a dispersion of the isocyanate-terminated prepolymer, in the second step (formation step of isocyanate-terminated prepolymer);

adding the monofunctional active hydrogen-containing compound (c) to the dispersion obtained in the second step, reacting the isocyanate-terminated prepolymer and the monofunctional active hydrogen-containing compound (c) to form the isocyanate-terminated prepolymer (II), and preparing its dispersion, as a pre-step of the third step;

adding water to the dispersion obtained in the pre-step, subjecting the isocyanate-terminated prepolymer (II) and water (e) to chain extension reaction to form the polyurethane urea resin, and preparing its dispersion, in the third step (formation step of polyurethane urea resin); and

separating and drying the polyurethane urea resin from the dispersion obtained in the third step, in the fourth step (preparation step of powdered thermoplastic polyurethane urea resin).

(4) A process for producing a powdered thermoplastic polyurethane urea resin by:

reacting the polymer polyol (a) and the organic polyisocyanate (b) to prepare a dispersion of the isocyanate-terminated prepolymer (I), in the second step (formation step of isocyanate-terminated prepolymer);

adding the monofunctional active hydrogen-containing compound (c) and the bifunctional active hydrogen-containing compound (d) to the dispersion obtained in the second step, reacting the isocyanate-terminated prepolymer, the monofunctional active hydrogen-containing compound (c) and the bifunctional active hydrogen-containing compound (d) to form the isocyanate-terminated prepolymer (II), and preparing its dispersion, as a pre-step of the third step;

adding water to the dispersion obtained in the pre-step, subjecting the isocyanate-terminated prepolymer (II) and water (e) to chain extension reaction to form the polyurethane urea resin, and preparing its dispersion, in the third step (formation step of polyurethane urea resin); and

separating and drying the polyurethane urea resin from the dispersion obtained in the third step, in the fourth step (preparation step of powdered thermoplastic polyurethane urea resin).

The above production processes (1) to (4) are a specific process for reacting the isocyanate group in the isocyanate-terminated prepolymer (II) and the active hydrogen group in water (e) by reacting the polymer polyol (a), the organic polyisocyanate (b), the monofunctional active hydrogen-containing compound (c) and the bifunctional active hydrogen-containing compound (d) before conducting the chain extension reaction with water (e) to obtain the isocyanate-terminated prepolymer (II), and then adding excess amount of water. When excess amount of water is added, the isocyanate group in the isocyanate-terminated prepolymer (II) can completely be consumed (ureation) without influenced with loss of water by evaporation or the like. The above production processes (1) to (4) are preferred in this point. Where water in an amount nearly equivalent to the isocyanate group in the isocyanate-terminated prepolymer (II) is added, or where water is added with other timing, water is used for evaporation or side reaction, resulting in less than equivalent amount, and as a result, the isocyanate group remains in the polyurethane urea resin obtained.

### Powered Thermoplastic Polyurethane Urea Resin

The shape of the powdered thermoplastic polyurethane urea resin obtained by the production process of the invention (first invention and second invention) is a truly spherical shape having good fluidity (flowability at the time of molding processing). The powdered thermoplastic polyurethane urea resin has an angle of repose of preferably 35° or less, and more preferably from 20 to 33°. Where the angle of repose is excessively large, flowability at the time of molding processing deteriorates, and defective molding is liable to occur.

When a bulk resin is freeze pulverized, the angle of the powdered thermoplastic polyurethane urea resin produced exceeds 33°.

The powdered thermoplastic polyurethane urea resin obtained by the production process of the invention has a number average molecular weight (Mn) of preferably from 18,000 to 50,000, and more preferably from 20,000 to 45,000.

Where the number average molecular weight (Mn) is too small, sufficient mechanical properties and durability cannot be imparted to a molding finally obtained.

On the other hand, where the number average molecular weight (Mn) is too large, preferred melt formability cannot be exhibited (see Comparative Examples I-1, I-2 and I-8, and Comparative Examples II-3 and II-7 to 11-9, described hereinafter).

The “number average molecular weight (Mn) of the polyurethane urea resin” used herein means a value obtained from peaks other than peak of ultrahigh molecular weight (Mn is 500,000 or more) by GPC measurement.

The powdered thermoplastic polyurethane urea resin obtained by the production process of the invention has a weight average molecular weight (Mw) of preferably from 43,000 to 110,000, and more preferably from 47,000 to 100,000.

The “weight average molecular weight (Mn) of the polyurethane urea resin” used herein means a value obtained from peaks other than peak of ultrahigh molecular weight by GPC measurement.

The powdered thermoplastic polyurethane urea resin obtained by the production process of the invention has an average particle size of 1,000 μm or less, preferably from 10 to 500 μm, and more preferably from 90 to 200 μm.

Where the average particle size is too large, pinhole are liable to be generated at an undercut part and a corner part.

On the other hand, where the average particle size is too large, flowability and powder breakoff become worse, and wall thickness of a molding obtained is liable to be non-uniform.

The “average particle size” used herein means a value of cumulative percent at 50% in a particle size distribution curve measured by a laser particle size analyzer.

The average particle size of the powdered thermoplastic polyurethane urea resin can be controlled by concurrently using non-polar and/or low polar dispersion media and a polar dispersion medium.

According to need, additives can be added to the powdered thermoplastic polyurethane urea resin obtained by the production process of the invention. Examples of the additives include pigments, dyes, antioxidants, ultraviolet absorbers, plasticizers, antiblocking agents, radial polymerization initiators, coupling agents, flame retardants, inorganic and organic fillers, lubricants, antistatic agents and crosslinking agents.

Examples of the plasticizer include phthalic acid esters such as dibutyl phthalate, diisobutyl phthalate, dihexyl phthalate, diheptyl phthalate, di-(2-ethylhexyl)phthalate, di-n-octyl phthalate, dinonyl phthalate, diisononyl phthalate, diisodecyl phthalate, diundecyl phthalate, ditridecyl phthalate, dicyclohexyl phthalate, diphenyl phthalate, dibenzyl phthalate, butylbenzyl phthalate and myristylbenzyl phthalate; isophthalic acid esters such as di-(2-ethylhexyl)isophthalate and diisooctyl isophthalate; tetrahydrophthalic acid esters such as di-2-ethylhexyl tetrahydrophthalate; adipic acid esters such as di-(2-ethylhexyl)adipate, dibutoxyethyl adipate and diisononyl adipate; azelaic acid esters such as di-n-hexyl azelate and di-(2-ethylhexyl)azelate; sebacic acid esters such as di-n-butyl sebacate; maleic acid esters such as di-n-butyl maleate and di-(2-ethylhexyl)maleate; fumaric acid esters such as di-n-butyl fumarate and di-(2-ethylhexyl)fumarate; trimellitic acid esters such as tri-(2-ethylhexyl)trimellitate, tri-n-octyl trimellitate and triisooctyl trimellitate; pyromellitic acid esters such as tetra-(2-ethylhexyl)pyromellitate and tetra-n-octyl pyromellitate; citric acid esters such as tri-n-butyl citrate and acetyl tributyl citrate; itaconic acid esters such as dimethyl itaconate, diethyl itaconate, dibutyl itaconate and di-(2-ethylhexyl)itaconate; oleic acid esters such as glyceryl monooleate and diethylene glycol monooleate; recinolic acid derivatives such as glyceryl monorecinolate and diethylene glycol monorecinolate; stearic acid esters such as glycerin monostearate and diethylene glycol distearate; fatty acid esters such as ethylene glycol dipelargonate and pentaerythritol fatty acid ester; phosphoric acid esters such as tributoxyethyl phosphate, triphenyl phosphate, tricresyl phosphate, diphenyldecyl phosphate and diphenyloctyl phosphate; glycol derivatives such as diethylene glycol dibenzoate, triethylene glycol dibenzoate, triethylene glycol di-(2-ethylhexoate), tripropylene glycol dibenzoate and dibutylmethylene bisthioglycolate; glycerin derivatives such as glycerol monoacetate, glycerol triacetate and glycerol tributyrate; epoxy derivatives such as epoxidized soybean oil, epoxybutyl stearate, di-2-ethylhexyl epoxyhexahydrophthalate, diisodecyl epoxyhexahydrophthalate, epoxytriglyceride, epoxidized octyl oleate and epoxidized decyl oleate; adipic acid polyesters; sebacic acid polyesters; and phthalic acid polyesters.

Examples of the pigment include organic pigments such as insoluble azo pigment, soluble azo pigment, copper phthalocyanine pigment and quinacridone pigment; and inorganic pigments such as chromic acid salt, ferrocyan compound, metal oxide, metal salts (sulfate, silicate, carbonate, phosphate and the like), metal powder and carbon black. The amount of the pigment added is generally 5% by mass or less, and preferably from 1 to 3% by mass, based on the powdered thermoplastic polyurethane urea resin.

Examples of the antioxidant include phenol types (2,6-di-t-butyl-p-cresol, butyrated hydroxyanisole and the like), bisphenol types (2,2′-methylenebis(4-methyl-6-t-butylphenol and the like), and phosphorus types (triphenyl phosphite, diphenyl isodecyl phosphite and the like). Those can be used alone or as mixtures of two or more thereof.

Examples of the ultraviolet absorber include benzophenone types (2,4-dihydroxybenzophenone, 2-hydroxy-4-methoxybenzophenone and the like), benzotriazole types (2-(2′-hydroxy-5′-methylphenyl)benzotriazole and the like), salicylic acid types (phenyl salicylate and the like), and hindered amine types (bis(2,2,6,6-tetramethyl-4-piperidyl)sebacate and the like). Those can be used alone or as mixtures of tow or more thereof.

The amount of the antioxidant and ultraviolet absorber add is generally 5% by mass or less, and preferably from 0.01 to 3% by mass, based on the powdered thermoplastic polyurethane urea resin.

The antiblocking agent is not particularly limited, and can include the conventional inorganic antiblocking agents and organic antiblocking agents.

Examples of the inorganic antiblocking agent include silica, talc, titanium oxide and calcium carbonate, and examples of the organic antiblocking agent include thermosetting resins having a particle size of 10 μm or less (for example, a thermosetting polyurethane resin, a guanamine resin and an epoxy resin), and thermoplastic resins having a particle size of 10 μm or less (for example, a thermoplastic polyurethane urea resin and a poly(meth)acrylate resin).

Of those, the organic antiblocking agent is preferred, and the poly(meth)acrylate resin powder is particularly preferred.

The amount of the antiblocking agent added is generally less than 3% by mass, and preferably from 0.1 to 2% by mass, based on the powdered thermoplastic polyurethane urea resin.

### Slush Molding Method

The powdered thermoplastic polyurethane urea resin obtained by the production process of the invention can preferably be used as a powder material for slush molding.

One example of the slush molding method is described below.

A mold (metallic mold) is coated with a release agent, and then heated. Application of the release agent is conducted at 60° C. or lower. The coating method of the release agent can include an air spray method and a blush coating method. The heating temperature of the mold is generally from 150 to 300° C., and preferably from 180 to 280° C. The heating method can include a sand heating method and an oil heating method.

The powder material (the powdered thermoplastic polyurethane urea resin obtained by the production process of the invention) is charged in the mold, and held therein for from 15 to 45 seconds (flouring). Excess powder material is removed, and the mold is placed in a heating oven of 200 to 400° C., and heated therein for generally from 20 to 300 seconds, and preferably from 30 to 120 seconds, to complete melting of the powder material.

The mold taken out of the heating oven is cooled by a water cooling method or the like, and the content is demolded to obtain a slush molding (for example, a sheet having a thickness of from 0.7 to 2 mm).

Furthermore, when the slush molding (sheet) is not immediately taken out of the mold, and a polyurethane forming material is introduced into the same mold and foamed to form a core material comprising a polyurethane foam, followed by demolding, a member having a skin layer comprising a slush molding (for example, instrument panel, console box, arm rest and the like of automobiles) can be produced. Examples of the polyurethane foam include a soft foam and a semi-rigid foam, having a density of from 0.02 to 0.5 g/cm³.

### EXAMPLES

The present invention will be illustrated with reference to the following Examples, but the invention should not be construed as being limited thereto.

### Preparation Example 1

### Preparation of Dispersing Agent Solution

762 g of adipic acid, 49 g of maleic anhydride and 386 g of ethylene glycol were charged in a reactor having a volume of 2 liters equipped with a stirring device, a thermometer, a distillation column and a nitrogen gas introduction pipe, and were stirred under the conditions of 150° C. and ordinary pressures while flowing nitrogen gas to conduct esterification reaction.

At the time that condensed water was not recognized, 0.1 g of tetrabutyl titanate was added, and the reaction was continued while gradually reducing pressure in a reaction system to 0.07 kPa, and simultaneously gradually rising temperature to 190° C., thereby obtaining a polyester. The polyester obtained had a number average molecular weight of 2,000 and an iodine value of 12.7 μl/100 g.

Subsequently, 74 g of the polyester obtained above and 150 g of butyl acetate were charged in a reactor having a volume of 500 ml equipped with a stirring device, a thermometer, a distillation column and a nitrogen gas introduction pipe, and the temperature was elevated to 110° C. while flowing nitrogen gas, followed by stirring. Thereafter, a dissolved mixture of 75 g of 2-ethylhexyl methacrylate and 1 g of benzoyl peroxide were added dropwise from a dropping funnel over 1 hour. After completion of the dropwise addition, the temperature was elevated to 130° C. and the reaction was conducted for 2 hours, thereby obtaining a dispersing agent solution having a solid content of 50%. This is hereinafter referred to as “dispersing agent solution (1)”.

### Preparation Example 2

### Preparation of Dispersing Agent Solution

A dispersing agent solution having a solid content of 60% was obtained in the same manner as in Preparation Example 1, except that 113 g of diisononyl adipate (DINA) was used in place of butyl acetate, and 96 g of lauryl methacrylate was used in place of 2-ethylhexyl methacrylate. This is hereinafter referred to as “dispersing agent solution (2)”.

### Example I-1

### (1) First Step

756.9 g of a polyester diol (EA-2000) having a number average molecular weight of 2,000 obtained from ethylene glycol and adipic acid, 133.6 g of a polyester diol (HoP-1500) having a number average molecular weight of 1,500 obtained from 1,6-HD and orthophthalic acid, 7.4 g of the dispersing agent solution (1), and 818.2 g of isooctane “KYOWA SOL C-800” (a product of Kyowa Hakko Chemical Co., Ltd.) as a non-aqueous dispersion medium were charged in a reactor having a volume of 3 liters equipped with a stirring device, a thermometer, a condenser and a nitrogen gas introduction pipe, and stirred at 90 to 95° C. for 1 hour to disperse the polymer polyol (a) (EA-2000 and HoP-1500) in isooctane, thereby preparing a non-aqueous dispersion.

### (2) Second Step

102.2 g of hexamethylene diisocyanate (HDI) as the organic polyisocyanate (b), and 0.050 g of a bismuth catalyst “NEOSTAN U-600” (a product of Nitto Chemical Industry Co., Ltd.) were added to the dispersion obtained in the first step to react the polymer polyol (a) and HDI at 90 to 95° C. for 3 hours, thereby obtaining a dispersion of an isocyanate-terminated prepolymer.

The proportion of HDI and the polymer polyol (a) used is a proportion that the ratio (NCO)/(OH) between the isocyanate group in HDI and the polyol group in (a) is 1.30.

### (3) Pre-Step of Third Step

5.0 g of di-dodecylamine as the monofunctional active hydrogen-containing compound (c) was added to the dispersion of the isocyanate-terminated prepolymer obtained in the second step to react the isocyanate-terminated prepolymer and di-dodecylamine at 65 to 70° C., thereby forming an isocyanate-terminated prepolymer (I), and its dispersion was prepared.

### (4) Third Step

24 g of water (corresponding to 10 equivalents of the isocyanate group (calculated value=0.133 mol) in the isocyanate-terminated prepolymer (I)) was added to the dispersion obtained in the pre-step of the third step, and the isocyanate-terminated prepolymer (I) and water (e) were reacted at 65 to 70° C. until the isocyanate is consumed, thereby preparing a dispersion of a polyurethane urea resin.

In this Example, the ratio ((x1+x3)/A) is 0.30, and the ratio (x1/x3) is 5/95.

### (5) Fourth Step

A solid content (polyurethane urea resin) was filtered off from the dispersion of the polyurethane urea resin obtained in the third step, and the additives (i) to (v) shown below were added to the solid content. After drying the resulting mixture, 0.30 g of a dusty agent “MP1451” (a product of Soken Chemical and Engineering Co., Ltd.) was added to the dried mixture to prepare a powdered thermoplastic polyurethane urea resin. The resin obtained had a truly spherical shape and an angle of repose of 26°.

### Additives

(i) Black pigment: A mixture of a carbon black-dispersed pigment “PV-817” (a product of Sumika Color Co., Ltd.) and a titanium oxide-dispersed pigment “PV-7A1301” (a product of Sumika Color Co., Ltd.) (mixing ratio=70/30), addition amount=1.5% by mass based on the resin

(ii) Antioxidant: “IRGANOX 245” (a product of Ciba Specialty Chemicals K.K.), addition amount=0.25 g

(iii) Ultraviolet absorber: “TINUVIN 213” (a product of Ciba Specialty Chemicals K.K.), addition amount=0.15 g

(iv) Light stabilizing agent: “TINUVIN 765” (a product of Ciba Specialty Chemicals K.K.), addition amount=0.15 g

(v) Internal mold release agent: “SH200-100,000cs” (a product of Dow Corning Toray Co., Ltd.), addition amount=0.20 g

### Examples I-2 to I-15

Each of powdered thermoplastic polyurethane urea resins was prepared through the following first to fourth steps.

(1) First Step:

A non-aqueous dispersion was prepared in the same manner as in the first step of Example I-1, except that the polymer polyol (a), the dispersing agent solution and the non-aqueous dispersion medium (isooctane) were charged in the reactor according to the formulation shown in Table 1 below.

In Example I-2, 75 g of a plasticizer “PEG400 Dibenzoate” obtained from a polyethylene glycol 400 (1 mol) and benzoic anhydride (2 mols) was used; in Example I-5, 50 g of the plasticizer “PEG400 Dibenzoate” and 50 g of a plasticizer “PEG200 Dibenzoate” obtained from a polyethylene glycol 200 (1 mol) and benzoic anhydride (2 mols) were used; and in Example I-11, 50.0 g of the plasticizer “PEG200 Dibenzoate” was used.

### (2) Second Step:

A dispersion of an isocyanate-terminated prepolymer was prepared in the same manner as in the second step of Example I-1, except that HDI and a catalyst were added to the dispersion obtained in the first step of each Example according to the formulation shown in Table 1 below.

The values of the ratio (NCO)/(OH) between the isocyanate group in HDI used and the polyol group in the polymer polyol (a) used are shown in Table 1 below.

### (3) Pre-Step of Third Step:

The monofunctional active hydrogen-containing compound (c) was added to the dispersion of the isocyanate-terminated prepolymer obtained in the second step according to the formulation shown in Table 1 below to react the isocyanate-terminated prepolymer and the monofunctional active hydrogen-containing compound (c) at 65 to 70° C., thereby forming the isocyanate-terminated prepolymer (I), and its dispersion was prepared.

### (4) Third Step:

Water (corresponding 10 equivalents of the isocyanate group in the isocyanate-terminated prepolymer (I)) was added to the dispersion obtained in the pre-step of the third step, and the isocyanate-terminated prepolymer (I) and water (e) were reacted at 65 to 70° C. until the isocyanate group is consumed, thereby preparing a dispersion of a polyurethane urea resin.

Values of the ratio ((x1+x3)/A) and the ratio (x1/x3) are shown in Table 1 below.

### (5) Fourth Step:

A solid content was filtered off from the dispersion of the polyurethane urea resin obtained in the third step, and the additives (i) to (v) used in Example I-1 were added to the solid content (the respective addition amount was the same as in Example I-1). After drying the resulting mixture, 0.30 g of the dusty agent “MP1451” was added to the dried mixture to prepare a powdered thermoplastic polyurethane urea resin.

The resins obtained each had a truly spherical shape and an angle of repose of 26°.

TABLE 1

| | | Example | Example | Example | Example | Example | Example | Example | Example |
|---|---|---|---|---|---|---|---|---|---|
| | | I-1 | I-2 | I-3 | I-4 | I-5 | I-6 | I-7 | I-8 |
| Polymer | BA-1000 (g) | — | 546.1 | 238.4 | — | — | — | — | — |
| polyol | BA-2000 (g) | — | — | — | — | — | — | — | — |
| | BA-2500 (g) | — | — | 159.0 | — | — | 407.6 | 401.7 | 404.4 |
| | BEA-2600 (g) | — | — | — | 677.3 | 347.1 | — | — | — |
| | EA-1000 (g) | — | — | — | 169.3 | — | — | — | — |
| | EA-2000 (g) | 756.9 | — | — | — | 520.7 | — | — | — |
| | HiP-1000 (g) | — | 234.1 | 397.4 | — | — | 203.8 | 200.9 | 202.2 |
| | HoP-1500 (g) | 133.6 | — | — | — | — | 203.8 | 200.9 | 202.2 |
| Dispersing | Dispersing agent | 7.4 | — | 39.7 | 14.1 | — | — | 33.5 | — |
| agent | solution (1) (g) | | | | | | | | |
| | Dispersing agent | — | 6.5 | 39.7 | — | 21.7 | 34.0 | — | 33.7 |
| | solution (2) ) g) | | | | | | | | |

| | | | | | | | | |
|---|---|---|---|---|---|---|---|---|
| Isooctane (dispersion | 818.2 | 1000.0 | 1500.0 | 666.7 | 1000.0 | 1500.0 | 818.2 | 666.7 |
| medium) (g) | | | | | | | | |
| HDI (g) | 102.2 | 196.8 | 194.1 | 128.7 | 119.2 | 160.7 | 158.3 | 159.4 |
| U-600 (catalyst) (g) | 0.050 | 0.050 | 0.050 | 0.050 | 0.050 | 0.050 | 0.050 | 0.050 |
| Prepolymer (NCO)/(OH) | 1.30 | 1.50 | 1.65 | 1.78 | 1.80 | 1.90 | 1.90 | 1.90 |

| | | Example | Example | Example | Example | Example | Example | Example |
|---|---|---|---|---|---|---|---|---|
| | | I-9 | I-10 | I-11 | I-12 | I-13 | I-14 | I-15 |
| Polymer | BA-1000 (g) | 150.9 | 215.1 | — | — | — | 234.3 | 149.0 |
| polyol | BA-2000 (g) | — | — | 274.1 | 214.3 | — | — | — |
| | BA-2500 (g) | — | — | — | — | 436.8 | 156.2 | — |
| | BEA-2600 (g) | — | — | — | 178.6 | — | — | — |
| | EA-1000 (g) | — | 215.1 | — | — | — | — | — |
| | EA-2000 (g) | 150.9 | — | — | — | — | — | 149.0 |
| | HiP-1000 (g) | 301.8 | 71.7 | — | 321.4 | — | 390.4 | 74.5 |
| | HoP-1500 (g) | 150.9 | 215.1 | 509.1 | — | 436.8 | — | 327.5 |
| Dispersing | Dispersing agent | — | 23.9 | — | 59.5 | 7.3 | 39.0 | 18.6 |
| agent | solution (1) (g) | | | | | | | |
| | Dispersing agent | 31.4 | — | 3.9 | — | — | — | — |
| | solution (2) ) g) | | | | | | | |

| | | | | | | | |
|---|---|---|---|---|---|---|---|
| Isooctane (dispersion | 1000.0 | 1000.0 | 666.7 | 538.5 | 666.7 | 1000.0 | 818.2 |
| medium) (g) | | | | | | | |
| HDI (g) | 211.5 | 227.9 | 176.3 | 209.1 | 101.9 | 190.7 | 183.8 |
| U-600 (catalyst) (g) | 0.050 | 0.050 | 0.050 | 0.050 | 0.050 | 0.050 | 0.050 |
| Prepolymer (NCO)/(OH) | 2.00 | 2.10 | 2.20 | 2.50 | 1.30 | 1.65 | 2.00 |

| | | | Example | Example | Example | Example | Example | Example | Example | Example |
|---|---|---|---|---|---|---|---|---|---|---|
| | | | I-1 | I-2 | I-3 | I-4 | I-5 | I-6 | I-7 | I-8 |
| Monofunctional | Di-n-butylamine (g) | | — | 17.1 | — | — | — | — | — | — |
| active hydrogen- | Di-2-ethylhexylamine | | — | — | — | 19.4 | — | — | — | — |
| containing | (g) | | | | | | | | | |
| compound | Di-n-octylamine (g) | | — | — | — | — | 7.6 | — | — | — |
| | Di-allylamine (g) | | — | — | — | — | — | 17.6 | — | — |
| | Di-dodecylamine (g) | | 5.0 | — | — | — | — | — | 22.1 | — |
| | Dodecylamine (g) | | — | — | — | — | — | — | — | 8.3 |
| | n-Butanol (g) | | — | — | 3.4 | — | — | — | — | — |
| | n-Octanol (g) | | — | — | — | — | — | — | 9.3 | — |
| | Lauryl alcohol (g) | | — | — | — | — | — | — | — | 16.6 |
| Water | Addition amount | | 24 | 58 | 78 | 53 | 54 | 65 | 68 | 69 |
| | (excess amount) (g) | | | | | | | | | |
| | Reaction | Mass | 2.4 | 5.8 | 7.8 | 5.3 | 5.4 | 6.5 | 6.8 | 6.9 |
| | amount with | (g) | | | | | | | | |
| | NCO group | (mol) | 0.133 | 0.324 | 0.432 | 0.295 | 0.299 | 0.362 | 0.379 | 0.382 |
| | (calculated | | | | | | | | | |
| | value) | | | | | | | | | |

| | | | | | | | | |
|---|---|---|---|---|---|---|---|---|
| x1 | 0.014 | 0.133 | 0.045 | 0.080 | 0.032 | 0.181 | 0.133 | 0.135 |
| x3 | 0.266 | 0.648 | 0.864 | 0.590 | 0.598 | 0.724 | 0.758 | 0.764 |
| (x1 + x3) | 0.280 | 0.781 | 0.909 | 0.670 | 0.630 | 0.905 | 0.891 | 0.899 |
| A | 0.934 | 1.560 | 1.398 | 0.858 | 0.788 | 1.006 | 0.992 | 0.998 |
| (x1 + x3)/A | 0.30 | 0.50 | 0.65 | 0.78 | 0.80 | 0.90 | 0.90 | 0.90 |
| (x1/x3) | 5/95 | 17/83 | 5/95 | 12/88 | 5/95 | 20/80 | 15/85 | 15/85 |

| | | | Example | Example | Example | Example | Example | Example | Example |
|---|---|---|---|---|---|---|---|---|---|
| | | | I-9 | I-10 | I-11 | I-12 | I-13 | I-14 | I-15 |
| Monofunctional | Di-n-butylamine (g) | | — | — | — | — | — | — | — |
| active hydrogen- | Di-2-ethylhexylamine | | 15.2 | — | — | — | 22.9 | — | 52.8 |
| containing | (g) | | | | | | | | |
| compound | Di-n-octylamine (g) | | — | 17.1 | — | — | — | — | — |
| | Di-allylamine (g) | | — | — | — | — | — | — | — |
| | Di-dodecylamine (g) | | — | — | — | — | — | — | — |
| | Dodecylamine (g) | | — | — | — | — | — | — | — |
| | n-Butanol (g) | | 9.3 | — | — | — | — | 23.2 | 12.1 |
| | n-Octanol (g) | | — | 27.7 | — | 68.0 | — | — | — |
| | Lauryl alcohol (g) | | — | — | 31.8 | — | — | — | — |
| Water | Addition amount | | 96 | 102 | 88 | 87 | 17 | 52 | 64 |
| | (excess amount) (g) | | | | | | | | |
| | Reaction | Mass | 9.6 | 10.2 | 8.8 | 8.7 | 1.7 | 5.2 | 6.4 |
| | amount with | (g) | | | | | | | |
| | NCO group | (mol) | 0.534 | 0.568 | 0.486 | 0.485 | 0.092 | 0.290 | 0.355 |
| | (calculated | | | | | | | | |
| | value) | | | | | | | | |

| | | | | | | | |
|---|---|---|---|---|---|---|---|
| x1 | 0.189 | 0.284 | 0.172 | 0.522 | 0.095 | 0.313 | 0.383 |
| x3 | 1.068 | 1.136 | 0.972 | 0.970 | 0.184 | 0.580 | 0.710 |
| (x1 + x3) | 1.257 | 1.420 | 1.144 | 1.492 | 0.279 | 0.893 | 1.093 |
| A | 1.258 | 1.290 | 0.952 | 0.994 | 0.932 | 1.372 | 1.090 |
| (x1 + x3)/A | 1.00 | 1.10 | 1.20 | 1.50 | 0.30 | 0.65 | 1.00 |
| (x1/x3) | 15/85 | 20/80 | 15/85 | 35/65 | 34/66 | 35/65 | 35/65 |

Materials shown by abbreviation in the above Table 1 and Table 2 shown below are as follows.

BA-1000: Polyester diol having a number average molecular weight of 1,000, obtained from 1,4-BD and adipic acid.

BA-2000: Polyester diol having a number average molecular weight of 2,000, obtained from 1,4-BD and adipic acid.

BA-2500: Polyester diol having a number average molecular weight of 2,500, obtained from 1,4-BD and adipic acid.

BEA-2600: Polyester diol having a number average molecular weight of 2,600, obtained from 1,4-BD, ethylene glycol and adipic acid.

EA-1000: Polyester diol having a number average molecular weight of 1,000, obtained from ethylene glycol and adipic acid.

EA-2000: Polyester diol having a number average molecular weight of 2,000, obtained from ethylene glycol and adipic acid.

HiP-1000: Polyester diol having a number average molecular weight of 1,000, obtained from 1,6-HD and isophthalic acid.

HoP-1500: Polyester diol having a number average molecular weight of 1,500, obtained from 1,6-HD and orthophthalic acid.

Isooctane (dispersion medium): “KYOWA SOL C-800” (a product of Kyowa Hakko Chemical Co., Ltd.)

U-600 (catalyst): Bismuth catalyst “NEOSTAN U-600” (a product of Nitto Chemical Industry Co., Ltd.).

### Example I-16

The above Examples I-1 to I-15 are the production process (2) (production process of reacting the monofunctional active hydrogen-containing compound (c) in the pre-step of the third step) in the preferred production processes (1) and (2) according to the first invention.

Therefore, as a specific example of the production process (1) (production process of reacting the monofunctional active hydrogen-containing compound (c) in the second step) in the preferred production processes according to the first invention, a powdered thermoplastic polyurethane urea resin was prepared through the following first to fourth step according to the same formulation as in Example I-4.

(1) First step:

A non-aqueous dispersion was prepared in the same manner as in the first step of Example 1, except that 677.3 g of a polyester diol (BEA-2600), 169.3 g of a polyester diol (EA-1000), 19.4 g of di-2-ethylhexyl amine, 14.1 g of the dispersing agent solution (1) and 666.7 g of isooctane KYOWA SOL C-800 were charged.

(2) Second step:

128.7 g of HDI and 0.050 g of a catalyst NEOSTAN U-600 were added to the dispersion obtained in the first step, and the polymer polyol (a) to react HDI and di-2-ethylhexyl amine at 90 to 95° C. for 3 hours, thereby preparing a dispersion of the isocyanate-terminated prepolymer (I).

(3) Third step:

53 g of water was added to the dispersion obtained in the pre-step of the third step, and the isocyanate-terminated prepolymer (I) and water (e) were reacted at 65 to 70° C. until the isocyanate group was consumed, thereby preparing a dispersion of a polyurethane urea resin.

x1, x3 and A in this Example are the same as x1, x3 and A in Example 1-4, respectively.

(4) Fourth step:

Using the dispersion of the polyurethane urea resin obtained in the third step, a powdered thermoplastic polyurethane urea resin was prepared in the same manner as in the fourth step of Example I-1. The resin obtained had a truly spherical shape, and an angle of repose of 26°.

### Comparative Example I-1

A non-aqueous dispersion was prepared in the same manner as in the first step of Example I-1, except that 341.2 g of a polyester diol (EBA-2600), 511.8 g of a polyester diol (HiP-1000), 14.2 g of the dispersing agent solution (2) and 666.7 g of isooctane KYOWA SOL C-800 were charged in the reactor according to the formulation shown in Table 2 below.

A dispersion of an isocyanate-terminated prepolymer was prepared in the same manner as in the second step of Example I-1, except that 143.3 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.33.

38 g of water (corresponding to 10 equivalents of the isocyanate group) was added to the dispersion of the isocyanate-terminated prepolymer obtained, and the isocyanate-terminated prepolymer and water were reacted at 65 to 70° C. until the isocyanate was consumed, thereby preparing a dispersion of a polyurethane urea resin. In this Comparative Example, the ratio ((x1+x3)/A) is 0.33, and the ratio (x1/x3) is 0.

Using the dispersion of the polyurethane urea resin obtained, a powdered thermoplastic polyurethane urea resin was prepared in the same manner as in the fourth step of Example I-1.

This Comparative Example I-1 is a comparative example that does not use the monofunctional active hydrogen-containing compound (c).

### Comparative Example I-2

A non-aqueous dispersion was prepared in the same manner as in the first step of Example I-1, except that 612.0 g of a polyester diol (BA-2000), 262.3 g of a polyester diol (HoP-1500), 29.1 g of the dispersing agent solution (1) and 818.2 g of isooctane KYOWA SOL C-800 were charged in the reactor according to the formulation shown in Table 2 below.

A dispersion of an isocyanate-terminated prepolymer was prepared in the same manner as in the second step of Example I-1, except that 121.3 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.50.

43 g of water (corresponding to 10 equivalents of the isocyanate group) was added to the dispersion of the isocyanate-terminated prepolymer obtained, and the isocyanate-terminated prepolymer and water were reacted at 65 to 70° C. until the isocyanate was consumed, thereby preparing a dispersion of a polyurethane urea resin. In this Comparative Example, the ratio ((x1+x3)/A) is 0.50, and the ratio (x1/x3) is 0.

Using the dispersion of the polyurethane urea resin obtained, a powdered thermoplastic polyurethane urea resin was prepared in the same manner as in the fourth step of Example I-1.

This Comparative Example 1-2 is a comparative example that does not use the monofunctional active hydrogen-containing compound (c).

### Comparative Example 1-3

A non-aqueous dispersion was prepared in the same manner as in the first step of Example I-1, except that 384.4 g of a polyester diol (BA-1000), 192.2 g of a polyester diol (HiP-1000), 192.2 g of a polyester diol (HoP-1500), 25.6 g of the dispersing agent solution (2) and 600.0 g of isooctane KYOWA SOL C-800 were charged in the reactor according to the formulation shown in Table 2 below.

A dispersion of an isocyanate-terminated prepolymer was prepared in the same manner as in the second step of Example I-1, except that 197.5 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.67.

29.2 g of 1,6-HD was added to the dispersion of the isocyanate-terminated prepolymer, and a part of the isocyanate group in the isocyanate-terminated prepolymer obtained and the active hydrogen group (hydroxyl group) in 1,6-HD were reacted. 4.4 g of water (equivalent amount of the remainder of the isocyanate group) was added to this system, and the remainder of the isocyanate group in the isocyanate-terminated prepolymer obtained, and the active hydrogen group in water were reacted at 65 to 70° C., thereby preparing a dispersion of a polyurethane urea resin. In this Comparative Example, the ratio ((x1+x3)/A) is 0.35, and the ratio (x1/x3) is 0.

Using the dispersion of the polyurethane urea resin obtained, a powdered thermoplastic polyurethane urea resin was prepared in the same manner as in the fourth step of Example I-1.

This Comparative Example I-3 is a comparative example that a low molecular polyol was used in place of the monofunctional active hydrogen-containing compound (c).

### Comparative Example I-4

A non-aqueous dispersion was prepared in the same manner as in the first step of Example I-1, except that 401.0 g of a polyester diol (BA-2500), 200.5 g of a polyester diol (HiP-1000), 200.5 g of a polyester diol (HoP-1500), 33.4 g of the dispersing agent solution (1) and 818.2 g of isooctane KYOWA SOL C-800 were charged in the reactor according to the formulation shown in Table 2 below.

A dispersion of an isocyanate-terminated prepolymer was prepared in the same manner as in the second step of Example I-1, except that 158.1 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.90.

50.8 g of di-tridecylamine (active hydrogen-containing compound having an alkyl group having 13 carbon atoms) was added to the dispersion of the isocyanate-terminated prepolymer obtained, and a part of the isocyanate group in the isocyanate-terminated prepolymer and the active hydrogen group in di-ditridecylamine were reacted. 68 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

Using the dispersion of the polyurethane urea resin obtained, a powdered thermoplastic polyurethane urea resin was prepared in the same manner as in the fourth step of Example I-1.

This Comparative Example I-4 is a comparative example that the active hydrogen-containing compound having a long-chain alkyl group having carbon atoms exceeding 12 was used in place of the monofunctional active hydrogen-containing compound (c).

### Comparative Example I-5

A non-aqueous dispersion was prepared in the same manner as in the first step of Example I-1, except that 272.8 g of a polyester diol (BA-2000), 506.6 g of a polyester diol (HoP-1500), 3.9 g of the dispersing agent solution (2) and 666.7 g of isooctane KYOWA SOL C-800 were charged in the reactor according to the formulation shown in Table 2 below.

A dispersion of an isocyanate-terminated prepolymer was prepared in the same manner as in the second step of Example I-1, except that 175.5 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 2.20.

36.4 g of tetradecanol (active hydrogen-containing compound having an alkyl group having 14 carbon atoms) was added to the dispersion of the isocyanate-terminated prepolymer obtained, and a part of the isocyanate group in the isocyanate-terminated prepolymer and the active hydrogen group in tetradecanol were reacted. 87 g of water (corresponding to 10 equivalents of the remainder of the isocyanate group) was added to this system, and the remainder of the isocyanate group in the isocyanate-terminated prepolymer obtained, and the active hydrogen group in water were reacted at 65 to 70° C. until the isocyanate group was consumed, thereby preparing a dispersion of a polyurethane urea resin.

Using the dispersion of the polyurethane urea resin obtained, a powdered thermoplastic polyurethane urea resin was prepared in the same manner as in the fourth step of Example I-1.

This Comparative Example I-5 is a comparative example that an active hydrogen-containing compound having a long-chain alkyl group having carbon atoms exceeding 12 was used in place of the monofunctional active hydrogen-containing compound (c).

### Comparative Example I-6

A non-aqueous dispersion was prepared in the same manner as in the first step of Example I-1, except that 403.4 g of a polyester diol (BA-2500), 201.7 g of a polyester diol (HiP-1000), 201.7 g of a polyester diol (HoP-1500), 33.6 g of the dispersing agent solution (2) and 666.7 g of isooctane KYOWA SOL C-800 were charged in the reactor according to the formulation shown in Table 2 below.

A dispersion of an isocyanate-terminated prepolymer was prepared in the same manner as in the second step of Example I-1, except that 159.0 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.90.

28.8 g oftetradecanol (active hydrogen-containing compound having an alkyl group having 14 carbon atoms) was added to the dispersion of the isocyanate-terminated prepolymer obtained, and a part of the isocyanate group in the isocyanate-terminated prepolymer and the active hydrogen group in tetradecanol were reacted. 69 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

Using the dispersion of the polyurethane urea resin obtained, a powdered thermoplastic polyurethane urea resin was prepared in the same manner as in the fourth step of Example I-1.

This Comparative Example I-6 is a comparative example that an active hydrogen-containing compound having a long-chain alkyl group having carbon atoms exceeding 12 was used in place of the monofunctional active hydrogen-containing compound (c).

### Comparative Example I-7

A non-aqueous dispersion was prepared in the same manner as in the first step of Example I-1, except that 238.7 g of a polyester diol (BA-1000), 159.2 g of a polyester diol (BA-2500), 397.9 g of a polyester diol (HiP-1000), 39.8 g of the dispersing agent solution (1), 39.8 g of the dispersing agent solution (2) and 1500.0 g of isooctane KYOWA SOL C-800 were charged in the reactor according to the formulation shown in Table 2 below.

A dispersion of an isocyanate-terminated prepolymer was prepared in the same manner as in the second step of Example I-1, except that 194.3 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.65.

2.1 g of ethanol was added to the dispersion of the isocyanate-terminated prepolymer obtained, and a part of the isocyanate group in the isocyanate-terminated prepolymer and the active hydrogen group in ethanol were reacted. 78 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

Using the dispersion of the polyurethane urea resin obtained, a powdered thermoplastic polyurethane urea resin was prepared in the same manner as in the fourth step of Example I-1.

This Comparative Example I-7 is a comparative example that an active hydrogen-containing compound having an alkyl group having less than 4 carbon atoms was used in place of the monofunctional active hydrogen-containing compound (c).

### Comparative Example I-8

A non-aqueous dispersion was prepared in the same manner as in the first step of Example I-1, except that 413.2 g of a polyester diol (BA-2500), 206.6 g of a polyester diol (HiP-1000), 206.6 g of a polyester diol (HoP-1500), 34.4 g of the dispersing agent solution (2) and 1500.0 g of isooctane KYOWA SOL C-800 were charged in the reactor according to the formulation shown in Table 2 below.

A dispersion of an isocyanate-terminated prepolymer was prepared in the same manner as in the second step of Example I-1, except that 162.9 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.90.

2.7 g of di-allylamine as the monofunctional active hydrogen-containing compound was added to the dispersion of the isocyanate-terminated prepolymer obtained, and a part of the isocyanate group in the isocyanate-terminated prepolymer and the active hydrogen group in di-allylamine were reacted. 80 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

In this Comparative Example, the ratio ((x1+x3)/A) is 0.90, and the ratio (x1/x3) is 3/97.

Using the dispersion of the polyurethane urea resin obtained, a powdered thermoplastic polyurethane urea resin was prepared in the same manner as in the fourth step of Example I-1.

This Comparative Example I-8 is a comparative example that the ration (x1/x3) is less than 5/95 (the proportion of the monofunctional active hydrogen-containing compound is excessively small).

### Comparative Example I-9

A non-aqueous dispersion was prepared in the same manner as in the first step of Example I-1, except that 138.5 g of a polyester diol (BA-1000), 138.5 g of a polyester diol (EA-1000), 277.0 g of a polyester diol (HiP-1000), 138.5 g of a polyester diol (HoP-1500), 28.9 g of the dispersing agent solution (2) and 1000.0 g of isooctane KYOWA SOL C-800 were charged in the reactor according to the formulation shown in Table 2 below.

A dispersion of an isocyanate-terminated prepolymer was prepared in the same manner as in the second step of Example I-1, except that 194.1 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.79.

83.6 g of di-2-ethylhexylamine as the monofunctional active hydrogen-containing compound and 25.7 g of n-butanol as the monofunctional active hydrogen-containing compound were added to the dispersion of the isocyanate-terminated prepolymer obtained, and a part of the isocyanate group in the isocyanate-terminated prepolymer and the active hydrogen group in di-2-ethylhexylamine and n-butanol were reacted. 42 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

In this Comparative Example, the ratio ((x1+x3)/A) is 0.89, and the ratio (x1/x3) is 60/40.

Using the dispersion of the polyurethane urea resin obtained, a powdered thermoplastic polyurethane urea resin was prepared in the same manner as in the fourth step of Example I-1.

This Comparative Example I-9 is a comparative example that the ration (x1/x3) exceeds 35/65 (the proportion of the monofunctional active hydrogen-containing compound is excessively large).

### Comparative Example I-10

A non-aqueous dispersion was prepared in the same manner as in the first step of Example I-1, except that 226.6 g of a polyester diol (BA-2000), 188.8 g of a polyester diol (EBA-2600), 399.8 g of a polyester diol (HiP-1000), 62.9 g of the dispersing agent solution (1) and 538.5 g of isooctane KYOWA SOL C-800 were charged in the reactor according to the formulation shown in Table 2 below.

A dispersion of an isocyanate-terminated prepolymer was prepared in the same manner as in the second step of Example I-1, except that 221.1 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 2.50.

8.2 g of n-octanol as the monofunctional active hydrogen-containing compound was added to the dispersion of the isocyanate-terminated prepolymer obtained, and a part of the isocyanate group in the isocyanate-terminated prepolymer and the active hydrogen group in n-octanol were reacted. 135 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

In this Comparative Example, the ratio ((x1+x3)/A) is 1.50, and the ratio (x1/x3) is 4/96.

Using the dispersion of the polyurethane urea resin obtained, a powdered thermoplastic polyurethane urea resin was prepared in the same manner as in the fourth step of Example I-1.

This Comparative Example I-10 is a comparative example that the ration (x1/x3) is less than 5/95 (the proportion of the monofunctional active hydrogen-containing compound is excessively small).

### Comparative Example I-11

A non-aqueous dispersion was prepared in the same manner as in the first step of Example I-1, except that 435.9 g of a polyester diol (BA-2500), 435.9 g of a polyester diol (HoP-1500), 7.2 g of the dispersing agent solution (1) and 666.7 g of isooctane KYOWA SOL C-800 were charged in the reactor according to the formulation shown in Table 2 below.

A dispersion of an isocyanate-terminated prepolymer was prepared in the same manner as in the second step of Example I-1, except that 101.7 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.30.

24.9 g of di-2-ethylhexylamine as the monofunctional active hydrogen-containing compound was added to the dispersion of the isocyanate-terminated prepolymer obtained, and a part of the isocyanate group in the isocyanate-terminated prepolymer and the active hydrogen group in di-2-ethylhexylamine were reacted. 16 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

In this Comparative Example, the ratio ((x1+x3)/A) is 0.30, and the ratio (x1/x3) is 37/63.

Using the dispersion of the polyurethane urea resin obtained, a powdered thermoplastic polyurethane urea resin was prepared in the same manner as in the fourth step of Example I-1.

This Comparative Example I-11 is a comparative example that the ration (x1/x3) exceeds 35/65 (the proportion of the monofunctional active hydrogen-containing compound is excessively large).

### Comparative Example I-12

A non-aqueous dispersion was prepared in the same manner as in the first step of Example I-1, except that 234.0 g of a polyester diol (BA-1000), 156.0 g of a polyester diol (BA-2500), 390.0 g of a polyester diol (HiP-1000), 39.0 g of the dispersing agent solution (1) and 1000.0 g of isooctane KYOWA SOL C-800 were charged in the reactor according to the formulation shown in Table 2 below.

A dispersion of an isocyanate-terminated prepolymer was prepared in the same manner as in the second step of Example I-1, except that 190.5 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 1.65.

24.5 g of n-butanol as the monofunctional active hydrogen-containing compound was added to the dispersion of the isocyanate-terminated prepolymer obtained, and a part of the isocyanate group in the isocyanate-terminated prepolymer and the active hydrogen group in n-butanol were reacted. 51 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

In this Comparative Example, the ratio ((x1+x3)/A) is 0.65, and the ratio (x1/x3) is 37/63.

Using the dispersion of the polyurethane urea resin obtained, a powdered thermoplastic polyurethane urea resin was prepared in the same manner as in the fourth step of Example I-1.

This Comparative Example 1-12 is a comparative example that the ration (x1/x3) exceeds 35/65 (the proportion of the monofunctional active hydrogen-containing compound is excessively large).

### Comparative Example I-13

A non-aqueous dispersion was prepared in the same manner as in the first step of Example I-1, except that 148.1 g of a polyester diol (BA-1000), 148.1 g of a polyester diol (EA-2000), 74.1 g of a polyester diol (HiP-1500), 370.3 g of a polyester diol (HoP-1500), 18.5 g of the dispersing agent solution (1) and 818.2 g of isooctane KYOWA SOL C-800 were charged in the reactor according to the formulation shown in Table 2 below.

A dispersion of an isocyanate-terminated prepolymer was prepared in the same manner as in the second step of Example I-1, except that 182.7 g of HDI and 0.050 g of a catalyst NEOSTAN U-600 were added to the dispersion obtained. The proportion of HDI and the polymer polyol used is a proportion that the ratio (NCO)/(OH) between the isocyanate group in HDI and the polyol group in the polymer polyol is 2.00.

57.7 g of di-2-ethylhexylamine as the monofunctional active hydrogen-containing compound and 12.9 g of n-butanol as the monofunctional active hydrogen-containing compound were added to the dispersion of the isocyanate-terminated prepolymer obtained, and a part of the isocyanate group in the isocyanate-terminated prepolymer and the active hydrogen group in di-2-ethylhexylamine and n-butanol were reacted. 61 g of water (corresponding to 10 equivalents of the remainder of the isocyanate group) was added to this system, and the remainder of the isocyanate group in the isocyanate-terminated prepolymer, and the active hydrogen group in water were reacted at 65 to 70° C. until the isocyanate group was consumed, thereby preparing a dispersion of a polyurethane urea resin.

In this Comparative Example, the ratio ((x1+x3)/A) is 1.00, and the ratio (x1/x3) is 38/62.

Using the dispersion of the polyurethane urea resin obtained, a powdered thermoplastic polyurethane urea resin was prepared in the same manner as in the fourth step of Example I-1.

This Comparative Example I-13 is a comparative example that the ration (x1/x3) exceeds 35/65 (the proportion of the monofunctional active hydrogen-containing compound is excessively large).

TABLE 2

| | | Comparative | Comparative | Comparative | Comparative | Comparative | Comparative | Comparative |
|---|---|---|---|---|---|---|---|---|
| | | Example I-1 | Example I-2 | Example I-3 | Example I-4 | Example I-5 | Example I-6 | Example I-7 |
| High | BA-1000 (g) | — | — | 384.4 | — | — | — | 238.7 |
| molecular | BA-2000 (g) | — | 612.0 | — | — | 272.8 | — | — |
| polyol | BA-2500 (g) | — | — | — | 401.0 | — | 403.4 | 159.2 |
| | BEA-2600 (g) | 341.2 | — | — | — | — | — | — |
| | EA-1000 (g) | — | — | — | — | — | — | — |
| | EA-2000 (g) | — | — | — | — | — | — | — |
| | HiP-1000 (g) | 511.8 | — | 192.2 | 200.5 | — | 201.7 | 397.9 |
| | HoP-1500 (g) | — | 262.3 | 192.2 | 200.5 | 506.6 | 201.7 | — |
| Dispersing | Dispersing agent | — | 29.1 | — | 33.4 | — | — | 39.8 |
| agent | solution (1) (g) | | | | | | | |
| | Dispersing agent | 14.2 | — | 25.6 | — | 3.9 | 33.6 | 39.8 |
| | solution (2) (g) | | | | | | | |

| | | | | | | | |
|---|---|---|---|---|---|---|---|
| Isooctane (dispersion | 666.7 | 818.2 | 600.0 | 812.2 | 666.7 | 666.7 | 1500.0 |
| medium) (g) | | | | | | | |
| HDI (g) | 143.3 | 121.3 | 197.5 | 158.1 | 175.5 | 159.0 | 194.3 |
| U-600 (catalyst) (g) | 0.050 | 0.050 | 0.050 | 0.050 | 0.050 | 0.050 | 0.050 |
| Prepolymer (NCO)/(OH) | 1.33 | 1.50 | 1.67 | 1.90 | 2.20 | 1.90 | 1.65 |

| | | Comparative | Comparative | Comparative | Comparative | Comparative | Comparative |
|---|---|---|---|---|---|---|---|
| | | Example I-8 | Example I-9 | Example I-10 | Example I-11 | Example I-12 | Example I-13 |
| High | BA-1000 (g) | — | 138.5 | — | — | 234.0 | 148.1 |
| molecular | BA-2000 (g) | — | — | 226.6 | — | — | — |
| polyol | BA-2500 (g) | 413.2 | — | — | 435.9 | 156.0 | — |
| | BEA-2600 (g) | — | — | 188.8 | — | — | — |
| | EA-1000 (g) | — | 138.5 | — | — | — | — |
| | EA-2000 (g) | — | — | — | — | — | 148.1 |
| | HiP-1000 (g) | 206.6 | 277.0 | 339.8 | — | 390.0 | 74.1 |
| | HoP-1500 (g) | 206.6 | 138.5 | — | 435.9 | — | 370.3 |
| Dispersing | Dispersing agent | — | — | 62.9 | 7.2 | 39.0 | 18.5 |
| agent | solution (1) (g) | | | | | | |
| | Dispersing agent | 34.4 | 28.9 | — | — | — | — |
| | solution (2) (g) | | | | | | |

| | | | | | | |
|---|---|---|---|---|---|---|
| Isooctane (dispersion | 1500.0 | 1000.0 | 538.5 | 666.7 | 1000.0 | 818.2 |
| medium) (g) | | | | | | |
| HDI (g) | 162.9 | 194.1 | 221.1 | 101.7 | 190.5 | 182.7 |
| U-600 (catalyst) (g) | 0.050 | 0.050 | 0.050 | 0.050 | 0.050 | 0.050 |
| Prepolymer (NCO)/(OH) | 1.90 | 1.79 | 2.50 | 1.30 | 1.65 | 2.00 |

| | | | Comparative | Comparative | Comparative | Comparative | Comparative | Comparative | Comparative |
|---|---|---|---|---|---|---|---|---|---|
| | | | Example I-1 | Example I-2 | Example I-3 | Example I-4 | Example I-5 | Example I-6 | Example I-7 |
| Active | Di-2-ethylhexylamine (g) | | — | — | — | — | — | — | — |
| hydrogen- | Di-allylamine g) | | — | — | — | — | — | — | — |
| containing | Dodecylamine (g) | | — | — | — | — | — | — | — |
| compound | n-Butanol (g) | | — | — | — | — | — | — | — |
| | n-Octanol (g) | | — | — | — | — | — | — | — |
| | Di-tridecylamine (g) | | — | — | — | 50.8 | — | — | — |
| | Ethanol (g) | | — | — | — | — | — | — | 2.1 |
| | Tetradecanol (g) | | — | — | — | — | 36.4 | 28.8 | — |
| | 1,6-HD (g) | | — | — | 29.2 | — | — | — | — |
| Water | Addition amount (g) | | 38 | 43 | 4.4 | 68 | 87 | 69 | 78 |
| | Reaction amount | Mass | 3.8 | 4.3 | 4.4 | 6.8 | 8.7 | 6.9 | 7.8 |
| | | (g) | | | | | | | |
| | with NCO group | (mol) | 0.209 | 0.240 | 0.247 | 0.378 | 0.484 | 0.381 | 0.432 |
| | (calculated value) | | | | | | | | |

| | | | | | | | |
|---|---|---|---|---|---|---|---|
| x1 | 0 | 0 | 0 | 0 | 0 | 0 | 0 |
| x3 | 0.418 | 0.480 | 0.494 | 0.756 | 0.968 | 0.762 | 0.864 |
| (x1 + x3) | 0.418 | 0.480 | 0.494 | 0.756 | 0.968 | 0.762 | 0.864 |
| A | 1.286 | 0.962 | 1.408 | 0.990 | 0.948 | 0.994 | 1.402 |
| (x1 + x3)/A | 0.33 | 0.50 | 0.35 | 0.76 | 1.02 | 0.77 | 0.62 |
| (x1/x3) | 0 | 0 | 0 | 0 | 0 | 0 | 0 |

| | | | Comparative | Comparative | Comparative | Comparative | Comparative | Comparative |
|---|---|---|---|---|---|---|---|---|
| | | | Example I-8 | Example I-9 | Example I-10 | Example I-11 | Example I-12 | Example I-13 |
| Active | Di-2-ethylhexylamine (g) | | — | 83.6 | — | 24.9 | — | 57.7 |
| hydrogen- | Di-allylamine g) | | 2.7 | — | — | — | — | — |
| containing | Dodecylamine (g) | | — | — | — | — | — | — |
| compound | n-Butanol (g) | | — | 25.7 | — | — | 24.5 | 12.9 |
| | n-Octanol (g) | | — | — | 8.2 | — | — | — |
| | Di-tridecylamine (g) | | — | — | — | — | — | — |
| | Ethanol (g) | | — | — | — | — | — | — |
| | Tetradecanol (g) | | — | — | — | — | — | — |
| | 1,6-HD (g) | | — | — | — | — | — | — |
| Water | Addition amount (g) | | 80 | 42 | 135 | 16 | 51 | 61 |
| | Reaction amount | Mass (g) | 8.0 | 4.2 | 13.5 | 1.6 | 5.1 | 6.1 |
| | with NCO group | (mol) | 0.445 | 0.231 | 0.749 | 0.088 | 0.281 | 0.337 |
| | (calculated value) | | | | | | | |

| | | | | | | |
|---|---|---|---|---|---|---|
| x1 | 0.028 | 0.692 | 0.063 | 0.103 | 0.330 | 0.413 |
| x3 | 0.890 | 0.462 | 1.514 | 0.176 | 0.562 | 0.674 |
| (x1 + x3) | 0.918 | 1.154 | 1.577 | 0.279 | 0.892 | 1.087 |
| A | 1.020 | 1.290 | 1.052 | 0.930 | 1.37 | 1.09 |
| (x1 + x3)/A | 0.90 | 0.89 | 1.50 | 0.30 | 0.65 | 1.00 |
| (x1/x3) | 3/97 | 60/40 | 4/96 | 37/63 | 37/63 | 38/62 |

### Evaluation of Powdered Thermoplastic Polyurethane Urea Resin

Each of the powdered thermoplastic polyurethane urea resins obtained in Examples I-1 to I-16 and Comparative Examples I-1 to I-13 was measured and evaluated on the following items. The results are shown in Tables 3 and 4 below.

Comparative Examples 1-3 and 1-7 were not measured and evaluated on certain items.

### (1) Molecular Weight Measurement:

Proportion (peak area ratio in measurement chart) of a sparingly fusible material (component having a molecular weight of 500,000 or more), and a number average molecular weight (Mn) and a weight average molecular weight (Mw) of components excluding the sparingly fusible material were obtained by GPC measurement. The measurement conditions are as follows.

Measurement device: HLC-8120 (a product of Tosoh Corporation)

Column: TSKgel Multipore HXL-M (a product of Tosoh Corporation)
Particle size=5 μm
Size=7.8 mmID×30 cm×4

Carrier: Tetrahydrofuran (THF)

Detector: Parallax refraction

Sample: 1% Solution of THF/n-methylpyrrolidone=½

Calibration curve: Standard polystyrene

### (2) Average Particle Size:

Value of 50% cumulative percent in a particle size distribution curve measured with a laser particle size analyzer “Microtrack HRA” (a product of Nikkiso Co., Ltd.) was obtained.

### (3) Melt Formability (Leveling Property):

A powder polyurethane resin was heat melted for 10 seconds in a mold heated to 230° C. After removing unmelted powder and allowing the melt to stand in a 300° C. oven for 45 seconds, a molded sheet having a thickness of 1 mm was prepared by slush molding with water cooling. The molten state of the sheet thus obtained was visually observed, and evaluated according to the following standards.

### Evaluation Standard

AA: Defective melting is not observed.

A: Defective melting is slightly observed to an extent such that it is not remarkable.

C: Defective melting is considerably observed.

### (4) Melt Formability (Pinhole State):

Presence or absence, and the degree of pinhole on the surface of the sheet obtained in (3) above were visually observed, and evaluated according to the following standards.

### Evaluation Standard

AA: Pinhole is not observed.

A: Pinhole is slightly observed to an extent such that it is not remarkable.

C: Pinhole is considerably observed.

(5) Melt Formability (Green Strength Development Property when Demolding):

Presence or absence, and the degree of deformation when demolding the sheet obtained in (3) above were observed, and evaluated according to the following standards.

### Evaluation Standard

AA: Deformation is not observed.

A: Deformation is slightly observed.

C: Deformation is apparently observed.

### (6) Crease Resistance of Molding:

The sheet obtained in (3) above was allowed to stand for 30 seconds after demolding, held in a 180° folded state for 30 seconds, returned to the unfolded state, and allowed to stand for 24 hours. The folded portion was visually observed, and evaluated according to the following standards.

### Evaluation Standard

AA: Crease is not observed.

A: Crease is slightly observed to an extent such that it is not remarkable.

C: Crease is apparently observed.

### (7) Abrasion Resistance of Molding Surface:

The sheet obtained in (3) above was subjected to a test of 100 reciprocations using a reciprocating plane abrasion tester under the following conditions, and the state of sheet surface was visually observed, and evaluated according to the following standards.

### Conditions

Reciprocating speed: 40 times/min

Friction element: 30 mm×12 mm

Load: 29.4N

Abrasion material: Material obtained by laminating five white cotton shirting No. 3.

AA: Damage is not observed.

A: Damage is slightly observed to an extent such that it is not remarkable.

C: Damage is markedly observed.

### (8) Mechanical Properties of Molding:

The sheet obtained in (3) above was subjected to a tensile test and a tear test according to JIS K 6251-6252, and tensile strength, elongation at break and tear strength were measured.

### (9) Blooming Resistance of Molding:

The sheet obtained in (3) above was dipped in water at 50° C. for 48 hours, and then dried. Presence or absence, and the degree of blooming on the surface were visually observed, and evaluated according to the following standards.

AA: Blooming is not observed.

A: Blooming is slightly observed.

C: Blooming is markedly observed.

TABLE 3

| | | Example | Example | Example | Example | Example | Example | Example | Example |
|---|---|---|---|---|---|---|---|---|---|
| | | I-1 | I-2 | I-3 | I-4 | I-5 | I-6 | I-7 | I-8 |
| Number average molecular weight | | 35,000 | 25,000 | 35,000 | 32,000 | 42,000 | 21,000 | 30,000 | 32,000 |
| (Mn) | | | | | | | | | |
| Weight average molecular weight | | 80,000 | 60,000 | 80,000 | 75,000 | 95,000 | 50,000 | 78,000 | 81,000 |
| (Mw) | | | | | | | | | |
| Proportion of sparingly fusible | | 10 | 18 | 13 | 7 | 20 | 6 | 10 | 9 |
| material (PA %) | | | | | | | | | |
| Average particle size (μm) | | 95 | 140 | 180 | 130 | 200 | 120 | 250 | 150 |
| Melt formability | Leveling | A | A | A | AA | A | AA | AA | AA |
| | property | | | | | | | | |
| | State of | A | A | A | AA | A | AA | AA | AA |
| | pinhole | | | | | | | | |
| | Green strength | A | AA | AA | AA | AA | A | AA | AA |
| | development | | | | | | | | |
| | property when | | | | | | | | |
| | demolding | | | | | | | | |
| Crease resistance of molding | | A | AA | AA | AA | AA | A | AA | AA |
| Abrasion resistance of molding | | A | AA | AA | AA | AA | A | AA | AA |
| surface | | | | | | | | | |
| Mechanical | Tensile | 14 | 10 | 11 | 15 | 12 | 10 | 14 | 15 |
| property | strength (MPa) | | | | | | | | |
| | Elongation at | 500 | 550 | 530 | 580 | 400 | 450 | 590 | 550 |
| | break (%) | | | | | | | | |
| | Tear strength | 45 | 40 | 52 | 55 | 45 | 40 | 50 | 48 |
| | (kN/m) | | | | | | | | |
| Blooming resistance | | AA | AA | AA | AA | AA | AA | AA | AA |
| | | Example | Example | Example | Example | Example | Example | Example | Example |
| | | I-9 | I-10 | I-11 | I-12 | I-13 | I-14 | I-15 | I-16 |
| Number average molecular weight | | 27,000 | 24,000 | 33,000 | 21,000 | 20,000 | 22,000 | 21,000 | 31,000 |
| (Mn) | | | | | | | | | |
| Weight average molecular weight | | 55,000 | 60,000 | 78,000 | 50,000 | 42,000 | 44,000 | 42,000 | 74,000 |
| (Mw) | | | | | | | | | |
| Proportion of sparingly fusible | | 12 | 10 | 11 | 18 | 3 | 3 | 5 | 9 |
| material (PA %) | | | | | | | | | |
| Average particle size (μm) | | 85 | 175 | 140 | 160 | 145 | 165 | 150 | 130 |
| Melt formability | Leveling | AA | AA | AA | A | AA | AA | AA | AA |
| | property | | | | | | | | |
| | State of | AA | AA | AA | A | AA | AA | AA | AA |
| | pinhole | | | | | | | | |
| | Green strength | AA | AA | AA | AA | A | A | A | AA |
| | development | | | | | | | | |
| | property when | | | | | | | | |
| | demolding | | | | | | | | |
| Crease resistance of molding | | AA | AA | AA | AA | A | A | A | AA |
| Abrasion resistance of molding | | AA | AA | AA | AA | A | A | A | AA |
| surface | | | | | | | | | |
| Mechanical | Tensile | 16 | 18 | 13 | 16 | 8 | 8 | 11 | 14 |
| property | strength (MPa) | | | | | | | | |
| | Elongation at | 600 | 590 | 530 | 550 | 400 | 400 | 500 | 560 |
| | break (%) | | | | | | | | |
| | Tear strength | 55 | 60 | 59 | 54 | 35 | 40 | 45 | 56 |
| | (kN/m) | | | | | | | | |

| | | | | | | | | |
|---|---|---|---|---|---|---|---|---|
| Blooming resistance | AA | AA | AA | AA | AA | AA | AA | AA |

TABLE 4

| | | Comparative | Comparative | Comparative | Comparative | Comparative | Comparative | Comparative |
|---|---|---|---|---|---|---|---|---|
| | | Example I-1 | Example I-2 | Example I-3 | Example I-4 | Example I-5 | Example I-6 | Example I-7 |
| Number average molecular weight | | 60,000 | 78,000 | *1) | 29,000 | 35,000 | 33,000 | *2) |
| (Mn) | | | | | | | | |
| Weight average molecular weight | | 150,000 | 250,000 | | 76,000 | 81,000 | 84,000 | |
| (Mw) | | | | | | | | |
| Proportion of sparingly fusible | | 25 | 40 | | 11 | 9 | 10 | |
| material (PA %) | | | | | | | | |
| Average particle size (μm) | | 150 | 180 | 130 | 230 | 150 | 140 | — |
| Melt formability | Leveling | C | C | — | AA | AA | AA | — |
| | property | | | | | | | |
| | State of | C | C | — | AA | AA | AA | — |
| | pinhole | | | | | | | |
| | Green strength | AA | AA | — | AA | AA | AA | — |
| | development | | | | | | | |
| | property when | | | | | | | |
| | demolding | | | | | | | |
| Crease resistance of molding | | AA | AA | — | AA | AA | AA | — |
| Abrasion resistance of molding | | AA | AA | — | AA | AA | AA | — |
| surface | | | | | | | | |
| Mechanical | Tensile | 7 | 3 | — | 13 | 14 | 14 | — |
| property | strength (MPa) | | | | | | | |
| | Elongation at | 350 | 320 | — | 600 | 530 | 540 | — |
| | break (%) | | | | | | | |
| | Tear strength | 35 | 25 | — | 52 | 56 | 50 | — |
| | (kN/m) | | | | | | | |

| | | | | | | | |
|---|---|---|---|---|---|---|---|
| Blooming resistance | AA | AA | — | C | C | C | — |

| | | Comparative | Comparative | Comparative | Comparative | Comparative | Comparative |
|---|---|---|---|---|---|---|---|
| | | Example I-8 | Example I-9 | Example I-10 | Example I-11 | Example I-12 | Example I-13 |
| Number average molecular weight | | 52,000 | 13,000 | 31,000 | 14,000 | 16,000 | 16,000 |
| (Mn) | | | | | | | |
| Weight average molecular weight | | 130,000 | 31,000 | 95,000 | 30,000 | 35,000 | 32,000 |
| (Mw) | | | | | | | |
| Proportion of sparingly fusible | | 25 | 4 | 60 | 2 | 2 | 3 |
| material (PA %) | | | | | | | |
| Average particle size (μm) | | 130 | 100 | 160 | 150 | 160 | 150 |
| Melt formability | Leveling | C | AA | C | AA | AA | AA |
| | property | | | | | | |
| | State of | C | AA | C | AA | AA | AA |
| | pinhole | | | | | | |
| | Green strength | AA | C | AA | C | C | C |
| | development | | | | | | |
| | property when | | | | | | |
| | demolding | | | | | | |
| Crease resistance of molding | | AA | C | AA | C | C | C |
| Abrasion resistance of molding | | AA | C | AA | C | C | C |
| surface | | | | | | | |
| Mechanical | Tensile | 5 | 9 | 3 | 5 | 6 | 8 |
| property | strength (MPa) | | | | | | |
| | Elongation at | 320 | 600 | 200 | 330 | 350 | 400 |
| | break (%) | | | | | | |
| | Tear strength | 33 | 40 | 18 | 25 | 28 | 33 |
| | (kN/m) | | | | | | |

| | | | | | | |
|---|---|---|---|---|---|---|
| Blooming resistance | AA | A | AA | AA | AA | AA |

*1) Molecular weight varied every lot. This was due to that it was attempted to control the reaction between the remainder of the isocyanate group and the active hydrogen group in water at R = 0.98, but a part of water added evaporated, and the active hydrogen group in a given amount (amount equivalent to the remainder of isocyanate) could not surely be reacted with the remainder of the isocyanate group.
*2) Molecular weight greatly varied every lot. This is considered to be due to evaporation of ethanol.

### Example II-1

### (1) First Step

170.2 g of a polyester diol (PBA-1000) having a number average molecular weight of 1,000 obtained from 1,4-BD and adipic acid, 255.3 g of a polyester diol (PBEA-2600) having a number average molecular weight of 2,600 obtained from 1,4-BD, ethylene glycol and adipic acid, 255.3 g of polyester diol (PHiP-1000) having a number average molecular weight of 1,000 obtained from 1,6-HD and isophthalic acid, 170.2 g of a polyester diol (PHoP-1500) having a number average molecular weight of 1,500 obtained from 1,6-HD and orthophthalic acid, 9.23 g of di-2-ethylhexylamine (D-2EHA) as the monofunctional active hydrogen-containing compound (c), 18.4 g of the dispersing agent solution (1) and 670.6 g of isooctane “KYOWA SOL C-800” (a product of Kyowa Hakko Chemical Co., Ltd.) as a non-aqueous dispersion medium were charged in a reactor having a volume of 3 liters equipped with a stirring device, a thermometer, a condenser and a nitrogen gas introduction pipe, and stirred at 90 to 95° C. for 1 hour to disperse the polymer polyol (a) (PBA-1000, PBEA-2600, PHiP-1000 and PHoP-1500) in isooctane, thereby preparing a non-aqueous dispersion.

### (2) Second Step

139.3 g of hexamethylene diisocyanate (HDI) as the organic polyisocyanate (b), and 0.050 g of a bismuth catalyst “NEOSTAN U-600” (a product of Nitto Chemical Industry Co., Ltd.) were added to the dispersion obtained in the first step to react the polymer polyol (a), HDI and di-2-ethylhexylamine at 90 to 95° C. for 3 hours, thereby forming an isocyanate-terminated prepolymer, and its dispersion was prepared.

### (3) Pre-Step of Third Step

2.41 g of 1,4-BD as the bifunctional active hydrogen-containing compound (d) and 1.36 g of 6-HD as the bifunctional active hydrogen-containing compound (d) were added to the dispersion obtained in the second step to react the isocyanate-terminated prepolymer, 1,4-BD and 1,6-HD at 65 to 70° C., thereby forming an isocyanate-terminated prepolymer (I), and its dispersion was prepared.

### (4) Third Step

24.1 g of water (corresponding to 10 equivalents of the isocyanate group (calculated value) in the isocyanate-terminated prepolymer (I)) was added to the dispersion obtained in the pre-step of the third step. The isocyanate-terminated prepolymer (I) and water were subjected to chain extension reaction at 65 to 70° C. until the isocyanate was consumed, thereby forming a polyurethane urea resin, and its dispersion was prepared.

In this Example, the ratio ((x1+x2+x3)/A) is 0.300, the ratio (x1/(x2+x3)) is 0.111, and the ratio (x2/x3) was 0.286.

### (5) Fourth Step

A solid content (polyurethane urea resin) was filtered off from the dispersion of the polyurethane urea resin obtained in the third step, and the additives (i) to (v) shown below were added to the solid content. After drying the resulting mixture, 0.30 g of a dusty agent “MP1451” (a product of Soken Chemical and Engineering Co., Ltd.) was added to the dried mixture to prepare a powdered thermoplastic polyurethane urea resin. The resin obtained had a truly spherical shape and an angle of repose of 26°.

### Additives

(i) Black pigment: A mixture of a carbon black-dispersed pigment “PV-817” (a product of Sumika Color Co., Ltd.) and a titanium oxide-dispersed pigment “PV-7A1301” (a product of Sumika Color Co., Ltd.) (mixing ratio=70/30), addition amount=1.5% by mass based on the resin.

(ii) Antioxidant: “IRGANOX 245” (a product of Ciba Specialty Chemicals K.K.), addition amount=0.25 g

(iii) Ultraviolet absorber: “TINUVIN 213” (a product of Ciba Specialty Chemicals K.K.), addition amount=0.15 g

(iv) Light stabilizing agent: “TINUVIN 765” (a product of Ciba Specialty Chemicals K.K.), addition amount=0.15 g

(v) Internal mold release agent: “SH200-100,000cs” (a product of Dow Corning Toray Co., Ltd.), addition amount=0.20 g

### Examples II-2 to II-14

Each of powdered thermoplastic polyurethane urea resins was prepared through the following first step, second step, pre-step of third step, third step and fourth step.

### (1) First Step:

A non-aqueous dispersion was prepared in the same manner as in the first step of Example II-1, except that the polymer polyol (a) (PBA-1000, PBEA-2600, PhiP-1000 and PHoP-1500), the monofunctional active hydrogen-containing compound (c), the dispersing agent solution (1) and the non-aqueous dispersion medium (isooctane) were charged in the reactor according to the formulation shown in Table 5 below.

### (2) Second Step:

An isocyanate-terminated prepolymer was formed in the same manner as in the second step of Example II-1, except that HDI and the catalyst “U-600” were added to the dispersion obtained in the first step of each Example according to the formulation shown in Table 5 below, and its dispersion was prepared.

### (3) Pre-Step of Third Step:

An isocyanate-terminated prepolymer (I) was formed in the same manner as in the pre-step of the third step in Example II-1, except that 1,4-BD and 1,6-HD were added to the dispersion obtained in the second step of each Example according to the formulation shown in Table 5 below, and its dispersion was prepared.

### (4) Third Step:

A polyurethane urea resin was formed in the same manner as in the third step in Example II-1, except that water (corresponding 10 equivalents of the isocyanate group (calculated value) in the isocyanate-terminated prepolymer (I)) was added to the dispersion obtained in the pre-step of the third step in each Example, and its dispersion was prepared.

In each Example, values of the ratio ((x1+x2+x3)/A), the ratio (x1/(x2+x3)) and the ratio (x2/x3) are shown in Table 5 below.

### (5) Fourth Step:

A solid content (polyurethane urea resin) was filtered off from the dispersion obtained in the third step of each Example, and the additives (i) to (v) used in Example II-1 were added to the solid content (the respective addition amount was the same as in Example II-1). After drying the resulting mixture, 0.30 g of the dusty agent “MP1451” was added to the dried mixture to prepare a powdered thermoplastic polyurethane urea resin.

The resins obtained each had a truly spherical shape and an angle of repose of 26°.

TABLE 5

| | | Example | Example | Example | Example | Example | Example | Example |
|---|---|---|---|---|---|---|---|---|
| | | II-1 | II-2 | II-3 | II-4 | II-5 | II-6 | II-7 |
| (a) | PBA-1000 (g) | 170.2 | 165.6 | 157.1 | 147.7 | 145.9 | 159.2 | 153.2 |
| | PBEA-2600 (g) | 255.3 | 248.4 | 235.7 | 221.5 | 218.9 | 238.7 | 229.8 |
| | PHiP-1000 (g) | 255.3 | 248.4 | 235.7 | 221.5 | 218.9 | 238.7 | 229.8 |
| | PHoP-1500 (g) | 170.2 | 165.6 | 157.1 | 147.7 | 145.9 | 159.2 | 153.2 |
| Dispersing agent solution (1) (g) | | 18.4 | 17.9 | 17.0 | 16.0 | 15.8 | 17.2 | 16.6 |
| Isooctane (dispersion medium) (g) | | 670.6 | 673.0 | 677.5 | 682.6 | 683.5 | 678.3 | 676.1 |
| (b) | HDI (g) | 139.3 | 156.4 | 188.0 | 223.1 | 229.7 | 190.4 | 183.3 |
| U-600 (catalyst) (g) | | 0.050 | 0.050 | 0.051 | 0.051 | 0.051 | 0.051 | 0.051 |
| (c) | D-2EHA (g) | 9.23 | 14.97 | 25.57 | 37.37 | 39.57 | 12.95 | 49.86 |
| | n-Butanol (g) | — | — | — | — | — | — | — |
| | n-Octanol (g) | — | — | — | — | — | — | — |
| | Lauryl alcohol (g) | — | — | — | — | — | — | — |
| (d) | 1,4-BD (g) | 2.41 | 3.91 | 6.68 | 9.76 | 10.34 | 7.15 | 5.80 |
| | 1,6-HD (g) | 1.36 | 2.20 | 3.75 | 5.49 | 5.81 | 4.02 | 3.26 |
| (e) | Water (addition amount) (g) | 24.1 | 39.1 | 66.8 | 97.6 | 103.3 | 71.4 | 57.8 |
| | Water (reaction amount) | 2.41 | 3.91 | 6.68 | 9.76 | 10.33 | 7.14 | 5.78 |
| | calculated value (g) | | | | | | | |
| x1 (mol) | | 0.038 | 0.062 | 0.106 | 0.155 | 0.164 | 0.054 | 0.206 |
| x2 (mol) | | 0.076 | 0.124 | 0.212 | 0.310 | 0.328 | 0.227 | 0.184 |
| x3 (mol) | | 0.268 | 0.434 | 0.741 | 1.083 | 1.147 | 0.792 | 0.642 |
| A (mol) | | 1.275 | 1.240 | 1.176 | 1.106 | 1.092 | 1.192 | 1.147 |
| (x1 + x2 + x3)/A | | 0.300 | 0.500 | 0.900 | 1.400 | 1.500 | 0.900 | 0.900 |
| x1/(x2 + x3) | | 0.111 | 0.111 | 0.111 | 0.111 | 0.111 | 0.053 | 0.250 |
| x2/x3 | | 0.286 | 0.286 | 0.286 | 0.286 | 0.286 | 0.286 | 0.286 |
| | | Example | Example | Example | Example | Example | Example | Example |
| | | II-8 | II-9 | II-10 | II-11 | II-12 | II-13 | II-14 |
| (a) | PBA-1000 (g) | 158.9 | 158.7 | 153.6 | 153.1 | 160.0 | 159.0 | 158.1 |
| | PBEA-2600 (g) | 238.4 | 238.1 | 230.4 | 229.6 | 239.9 | 238.5 | 237.1 |
| | PHiP-1000 (g) | 238.4 | 238.1 | 230.4 | 229.6 | 239.9 | 238.5 | 237.1 |
| | PHoP-1500 (g) | 158.1 | 158.7 | 153.6 | 153.1 | 160.0 | 159.0 | 158.1 |
| Dispersing agent solution (1) (g) | | 17.2 | 17.2 | 16.6 | 16.6 | 17.3 | 17.2 | 17.1 |
| Isooctane (dispersion medium) (g) | | 680.3 | 680.0 | 672.0 | 671.2 | 677.7 | 677.7 | 677.6 |
| (b) | HDI (g) | 190.1 | 189.9 | 183.7 | 183.1 | 191.4 | 190.2 | 189.1 |
| U-600 (catalyst) (g) | | 0.051 | 0.051 | 0.050 | 0.050 | 0.051 | 0.051 | 0.051 |
| (c) | D-2EHA (g) | 25.86 | 25.82 | 24.99 | 24.91 | — | — | — |
| | n-Butanol (g) | — | — | — | — | 7.99 | — | — |
| | n-Octanol (g) | — | — | — | — | — | 13.95 | — |
| | Lauryl alcohol (g) | — | — | — | — | — | — | 19.85 |
| (d) | 1,4-BD (g) | 1.01 | 1.69 | 17.95 | 19.52 | 6.80 | 6.76 | 6.72 |
| | 1,6-HD (g) | 0.57 | 0.95 | 10.09 | 10.97 | 3.82 | 3.80 | 3.78 |
| (e) | Water (addition amount) (g) | 83.9 | 81.9 | 32.6 | 27.9 | 68.0 | 67.6 | 67.2 |
| | Water (reaction amount) | 8.39 | 8.19 | 3.26 | 2.79 | 6.80 | 6.76 | 6.72 |
| | calculated value (g) | | | | | | | |

| | | | | | | | |
|---|---|---|---|---|---|---|---|
| x1 (mol) | 0.107 | 0.107 | 0.103 | 0.103 | 0.108 | 0.107 | 0.107 |
| x2 (mol) | 0.032 | 0.053 | 0.569 | 0.619 | 0.216 | 0.214 | 0.213 |
| x3 (mol) | 0.932 | 0.909 | 0.362 | 0.309 | 0.755 | 0.750 | 0.746 |
| A (mol) | 1.190 | 1.188 | 1.150 | 1.146 | 1.198 | 1.190 | 1.183 |
| (x1 + x2 + x3)/A | 0.900 | 0.900 | 0.900 | 0.900 | 0.900 | 0.900 | 0.900 |
| x1/(x2 + x3) | 0.111 | 0.111 | 0.111 | 0.111 | 0.111 | 0.111 | 0.111 |
| x2/x3 | 0.034 | 0.059 | 1.571 | 2.000 | 0.286 | 0.286 | 0.286 |

Materials shown by abbreviation in the above Table 5 and Table 6 are as follows.

PBA-1000: Polyester diol having a number average molecular weight of 1,000, obtained from 1,4-BD and adipic acid.

PBEA-2600: Polyester diol having a number average molecular weight of 2,600, obtained from 1,4-BD, ethylene glycol and adipic acid.

PHiP-1000: Polyester diol having a number average molecular weight of 1,000, obtained from 1,6-HD and isophthalic acid.

PHoP-1500: Polyester diol having a number average molecular weight of 1,500, obtained from 1,6-HD and orthophthalic acid.

Isooctane (dispersion medium): “KYOWA SOL C-800” (a product of Kyowa Hakko Chemical Co., Ltd.)

U-600 (catalyst): Bismuth catalyst “NEOSTAN U-600” (a product of Nitto Chemical Industry Co., Ltd.).

D-2EHA: Di-2-ethylhexylamine

### Comparative Examples II-1 to II-6

Each of powdered thermoplastic polyurethane urea resins was prepared through the following first step, second step, pre-step of third step, third step and fourth step.

### (1) First Step:

A non-aqueous dispersion was prepared in the same manner as in the first step of Example II-1, except that the polymer polyol (PBA-1000, PBEA-2600, PHip-1000 and PHoP-1500), di-2-ethylhexylamine (D-2EHA), the dispersing agent solution (1) and a non-aqueous dispersion medium (isooctane) were charged in the reactor according to the formulation shown in Table 6 below.

### (2) Second Step:

An isocyanate-terminated prepolymer was formed in the same manner as in the second step of Example II-1, except that HDI and a catalyst “U-600” were added to the dispersion obtained in the first step of each Comparative Example according to the formulation shown in Table 6 below, and its dispersion was prepared.

### (3) Pre-Step of Third Step:

An isocyanate-terminated prepolymer was formed in the same manner as in the pre-step of the third step in Example II-1, except that 1,4-BD and 1,6-HD were added to the dispersion obtained in the second step of each Comparative Example according to the formulation shown in Table 6 below, and its dispersion was prepared.

### (4) Third Step:

A polyurethane urea resin was formed in the same manner as in the third step of Example II-1, except that water (corresponding 10 equivalents of the isocyanate group (calculated value) in the isocyanate-terminated prepolymer) was added to the dispersion obtained in the pre-step of the third step in each Comparative Example, and its dispersion was prepared.

In each Comparative Example, values of the ratio ((x1+x2+x3)/A), the ratio (x1/(x2+x3)) and the ratio (x2/x3) are shown in Table 6 below.

Comparative Example II-1 and Comparative Example II-2 are the example that the value of the ratio ((x1+x2+x3)/A) is fallen outside the scope of the invention, Comparative Example II-3 and Comparative Example II-4 are the example that the value of the ratio (x1/(x2+x3)) is fallen outside the scope of the invention, and Comparative Example II-5 and Comparative Example II-6 are the example that the value of the ratio (x2/x3) is fallen outside the scope of the invention.

### (5) Fourth Step:

A solid content (polyurethane urea resin) was filtered off from the dispersion obtained in the third step of each Comparative Example, and the additives (i) to (v) used in Example II-1 were added to the solid content (the respective addition amount was the same as in Example II-1). After drying the resulting mixture, 0.30 g of the dusty agent “MP1451” was added to the dried mixture to prepare a powdered thermoplastic polyurethane urea resin.

The resins obtained each had a truly spherical shape and an angle of repose of 26°.

### Comparative Examples II-7 to 11-9

Each of powdered thermoplastic polyurethane urea resins was prepared through the following first step, second step, pre-step of third step, third step and fourth step.

### (1) First Step:

A non-aqueous dispersion was prepared in the same manner as in the first step of Example II-1, except that the polymer polyol (PBA-1000, PBEA-2600, PHiP-1000 and PHoP-1599), the dispersing agent solution (1) and a non-aqueous dispersion medium (isooctane) were charged in the reactor according to the formulation shown in Table 6 below.

### (2) Second Step:

An isocyanate-terminated prepolymer was formed in the same manner as in the second step of Example II-1, except that HDI and a catalyst “U-600” were added to the dispersion obtained in the first step of each Comparative Example according to the formulation shown in Table 6 below, and its dispersion was prepared.

### (3) Pre-Step of Third Step:

An isocyanate-terminated prepolymer was formed in the same manner as in the pre-step of the third step in Example II-1, except that 1,4-BD and 1,6-HD were added to the dispersion obtained in the second step of each Comparative Example according to the formulation shown in Table 6 below, and its dispersion was prepared.

### (4) Third Step:

A polyurethane urea resin was formed in the same manner as in the third step of Example II-1, except that water (corresponding 10 equivalents of the isocyanate group (calculated value) in the isocyanate-terminated prepolymer) was added to the dispersion obtained in the pre-step of the third step in each Comparative Example according to the formulation shown in Table 6 below, and its dispersion was prepared.

In each Comparative Example, values of the ratio ((x1+x2+x3)/A), the ratio (x1/(x2+x3)) and the ratio (x2/x3) are shown in Table 6 below.

Comparative Examples II-7 to II-9 are the example that the monofunctional active hydrogen-containing compound (c) is not used.

### (5) Fourth Step:

A solid content (polyurethane urea resin) was filtered off from the dispersion obtained in the third step of each Comparative Example, and the additives (i) to (v) used in Example II-1 were added to the solid content (the respective addition amount was the same as in Example II-1). After drying the resulting mixture, 0.30 g of the dusty agent “MP1451” was added to the dried mixture to prepare a powdered thermoplastic polyurethane urea resin.

The resins obtained each had a truly spherical shape and an angle of repose of 26°.

Each of powdered thermoplastic polyurethane urea resins was prepared through the following first step, second step, pre-step of third step, third step and fourth step.

### (1) First Step:

A non-aqueous dispersion was prepared in the same manner as in the first step of Example II-1, except that the polymer polyol (PBA-1000, PBEA-2600, PHiP-1000 and PHoP-1599), the monofunctional active hydrogen-containing compound, the dispersing agent solution (1) and the non-aqueous dispersion medium (isooctane) were charged in the reactor according to the formulation shown in Table 6 below.

### (2) Second Step:

An isocyanate-terminated prepolymer was formed in the same manner as in the second step of Example II-1, except that HDI and a catalyst “U-600” were added to the dispersion obtained in the first step of each Comparative Example according to the formulation shown in Table 6 below, and its dispersion was prepared.

### (3) Pre-Step of Third Step:

An isocyanate-terminated prepolymer was formed in the same manner as in the pre-step of the third step in Example II-1, except that 1,4-BD and 1,6-HD were added to the dispersion obtained in the second step of each Comparative Example according to the formulation shown in Table 6 below, and its dispersion was prepared.

### (4) Third Step:

A polyurethane urea resin was formed in the same manner as in the third step of Example II-1, except that water (corresponding 10 equivalents of the isocyanate group (calculated value) in the isocyanate-terminated prepolymer) was added to the dispersion obtained in the pre-step of the third step in each Comparative Example according to the formulation shown in Table 6 below, and its dispersion was prepared.

In each Comparative Example, values of the ratio ((x1+x2+x3)/A), the ratio (x1/(x2+x3)) and the ratio (x2/x3) are shown in Table 6 below.

Comparative Example II-10 is the example that di-tridecylamine (carbon atom number of hydrocarbon group=13) was used in place of the monofunctional active hydrogen-containing compound (c), Comparative Example II-11 is the example that ethanol (carbon atom number of hydrocarbon group=2) was used in place of the monofunctional active hydrogen-containing compound (c), and Comparative Example II-12 is the example that tetradecanol (carbon atom number of hydrocarbon group=14) was used in place of the monofunctional active hydrogen-containing compound (c).

Furthermore, in Comparative Examples II-10 to II-12, the amount of the monofunctional active hydrogen-containing compound charged was the amount that the molar ratio of the compound to the polymer polyol (a) consists with the molar ratio of di-2-ethylhexylamine to the polymer polyol (a) in Example II-3.

### (5) Fourth Step:

A solid content (polyurethane urea resin) was filtered off from the dispersion obtained in the third step of each Comparative Example, and the additives (i) to (v) used in Example II-1 were added to the solid content (the respective addition amount was the same as in Example II-1). After drying the resulting mixture, 0.30 g of the dusty agent “MP1451” was added to the dried mixture to prepare a powdered thermoplastic polyurethane urea resin.

The resins obtained each had a truly spherical shape and an angle of repose of 26°.

### Comparative Example II-13

A powdered thermoplastic polyurethane urea resin was prepared through the following first step, second step, third step and fourth step.

### (1) First Step:

A non-aqueous dispersion was prepared in the same manner as in the first step of Example II-1, except that the polymer polyol (PBA-1000, PBEA-2600, PHiP-1000 and PHoP-1500), the dispersing agent solution (1) and a non-aqueous dispersion medium (isooctane) were charged in the reactor according to the formulation shown in Table 6 below.

### (2) Second Step:

An isocyanate-terminated prepolymer was formed in the same manner as in the second step of Example II-1, except that HDI and a catalyst “U-600” were added to the dispersion obtained in the first step according to the formulation shown in Table 6 below, and its dispersion was prepared.

### (3) Third Step:

A polyurethane urea resin was formed in the same manner as in the third step of Example II-1, except that water (corresponding 10 equivalents of the isocyanate group (calculated value) in the isocyanate-terminated prepolymer) was added to the dispersion obtained in the second step according to the formulation shown in Table 6 below, and its dispersion was prepared.

In this Comparative Example, the ratio ((x1+x2+x3)/A), the ratio (x1/(x2+x3)) and the ratio (x2/x3) are all 0.

Comparative Example II-13 is the example that the mono functional active hydrogen-containing compound (c) and the bifunctional active hydrogen-containing compound (d) are not used.

### (4) Fourth Step:

A solid content (polyurethane urea resin) was filtered off from the dispersion obtained in the third step, and the additives (i) to (v) used in Example II-1 were added to the solid content (the respective addition amount was the same as in Example 1′-1). After drying the resulting mixture, 0.30 g of the dusty agent “MP1451” was added to the dried mixture to prepare a powdered thermoplastic polyurethane urea resin.

The resin obtained had a truly spherical shape and an angle of repose of 26°.

TABLE 6

| | | Comparative | Comparative | Comparative | Comparative | Comparative | Comparative | Comparative |
|---|---|---|---|---|---|---|---|---|
| | | Example | Example | Example | Example | Example | Example | Example |
| | | II-1 | II-2 | II-3 | II-4 | II-5 | II-6 | II-7 |
| (a) | PBA-1000 (g) | 172.6 | 142.5 | 160.0 | 149.5 | 159.0 | 152.8 | 161.5 |
| | PBEA-2600 (g) | 258.9 | 213.8 | 240.0 | 224.3 | 238.5 | 229.2 | 242.2 |
| | PHiP-1000 (g) | 258.9 | 213.8 | 240.0 | 224.3 | 238.5 | 229.2 | 242.2 |
| | PHoP-1500 (g) | 172.6 | 142.5 | 160.0 | 149.5 | 159.0 | 152.8 | 161.5 |
| Dispersing agent solution (1) (g) | | 18.7 | 15.4 | 17.3 | 16.2 | 17.2 | 16.6 | 17.5 |
| Isooctane (dispersion medium) (g) | | 669.3 | 685.3 | 678.6 | 674.7 | 680.5 | 670.7 | 679.4 |
| (b) | HDI (g) | 130.4 | 242.3 | 191.4 | 178.9 | 190.2 | 182.8 | 193.2 |
| U-600 (catalyst) (g) | | 0.050 | 0.051 | 0.051 | 0.051 | 0.051 | 0.050 | 0.051 |
| (c) | D-2EHA (g) | 6.24 | 43.80 | 7.81 | 72.98 | 25.87 | 24.86 | — |
| Di-tridecylamine (g) | | — | — | — | — | — | — | — |
| Ethanol (g) | | — | — | — | — | — | — | — |
| Tetradecanol (g) | | — | — | — | — | — | — | — |
| (d) | 1,4-BD (g) | 1.63 | 11.44 | 7.34 | 4.95 | 0.68 | 20.46 | 6.86 |
| | 1,6-HD (g) | 0.92 | 6.43 | 4.12 | 2.78 | 0.38 | 11.50 | 3.86 |
| (e) | Water (addition amount) (g) | 16.3 | 114.4 | 73.2 | 49.4 | 84.9 | 25.0 | 78.4 |
| | Water (reaction amount) | 1.63 | 11.44 | 7.32 | 4.94 | 8.49 | 2.50 | 7.84 |
| | calculated value (g) | | | | | | | |

| | | | | | | | |
|---|---|---|---|---|---|---|---|
| x1 (mol) | 0.026 | 0.181 | 0.032 | 0.302 | 0.107 | 0.103 | 0 |
| x2 (mol) | 0.052 | 0.363 | 0.233 | 0.157 | 0.021 | 0.649 | 0.218 |
| x3 (mol) | 0.181 | 1.270 | 0.813 | 0.548 | 0.943 | 0.278 | 0.871 |
| A (mol) | 1.292 | 1.067 | 1.198 | 1.119 | 1.191 | 1.144 | 1.209 |
| (x1 + x2 + x3)/A | 0.200 | 1.700 | 0.900 | 0.900 | 0.900 | 0.900 | 0.900 |
| x1/(x2 + x3) | 0.111 | 0.111 | 0.031 | 0.429 | 0.111 | 0.111 | 0 |
| x2/x3 | 0.286 | 0.286 | 0.286 | 0.286 | 0.023 | 2.333 | 0.250 |

| | | Comparative | Comparative | Comparative | Comparative | Comparative | Comparative |
|---|---|---|---|---|---|---|---|
| | | Example | Example | Example | Example | Example | Example |
| | | II-8 | II-9 | II-10 | II-11 | II-12 | II-13 |
| (a) | PBA-1000 (g) | 161.2 | 160.9 | 154.9 | 160.5 | 157.6 | 160.0 |
| | PBEA-2600 (g) | 241.9 | 241.4 | 232.3 | 240.7 | 236.4 | 240.0 |
| | PHiP-1000 (g) | 241.9 | 241.4 | 232.3 | 240.7 | 236.4 | 240.0 |
| | PHoP-1500 (g) | 161.2 | 160.9 | 154.9 | 160.5 | 157.6 | 160.0 |
| Dispersing agent solution (1) (g) | | 17.5 | 17.4 | 16.8 | 17.4 | 17.1 | 17.3 |
| Isooctane (dispersion medium) (g) | | 679.1 | 678.6 | 677.4 | 677.8 | 677.6 | 679.1 |
| (b) | HDI (g) | 192.9 | 192.5 | 185.3 | 191.9 | 188.5 | 191.7 |
| U-600 (catalyst) (g) | | 0.051 | 0.051 | 0.051 | 0.051 | 0.051 | 0.051 |
| (c) | D-2EHA (g) | — | — | — | — | — | — |
| Di-tridecylamine (g) | | — | — | 39.42 | — | — | — |
| Ethanol (g) | | — | — | — | 4.98 | — | — |
| Tetradecanol (g) | | — | — | — | — | 22.70 | — |
| (d) | 1,4-BD (g) | 7.63 | 8.55 | 6.58 | 6.82 | 6.70 | — |
| | 1,6-HD (g) | 4.29 | 4.81 | 3.70 | 3.83 | 3.76 | — |
| (e) | Water (addition amount) (g) | 76.1 | 73.3 | 65.8 | 68.2 | 67.0 | 97.2 |
| | Water (reaction amount) | 7.61 | 7.33 | 6.58 | 6.82 | 6.70 | 9.72 |
| | calculated value (g) | | | | | | |

| | | | | | | |
|---|---|---|---|---|---|---|
| x1 (mol) | 0 | 0 | 0 | 0 | 0 | 0 |
| x2 (mol) | 0.242 | 0.271 | 0.209 | 0.216 | 0.212 | 0 |
| x3 (mol) | 0.845 | 0.813 | 0.731 | 0.757 | 0.743 | 1.080 |
| A (mol) | 1.207 | 1.205 | 1.160 | 1.201 | 1.180 | 1.200 |
| (x1 + x2 + x3)/A | 0.900 | 0.900 | 0.810 | 0.810 | 0.810 | 0.900 |
| x1/(x2 + x3) | 0 | 0 | 0 | 0 | 0 | 0 |
| x2/x3 | 0.286 | 0.333 | 0.286 | 0.286 | 0.286 | 0 |

### Evaluation of Powdered Thermoplastic Polyurethane Urea Resin

Each of the powdered thermoplastic polyurethane urea resins obtained in Examples II-1 to II-14 and Comparative Examples II-1 to II-13 was measured and evaluated on the following items (1) to (12). The results are shown in Tables 7 and 8 below.

Comparative Example II-11 was not measured and evaluated on certain items.

### (1) Molecular Weight Measurement:

Proportion (peak area ratio in measurement chart) of a sparingly fusible material (component having Mn of 500,000 or more), and a number average molecular weight (Mn) and a weight average molecular weight (Mw) of components excluding the sparingly fusible material were obtained by GPC measurement. The measurement conditions are as follows.

Measurement device: HLC-8120 (a product of Tosoh Corporation)

Column: TSKgel Multipore H_{XL-M} (a product of Tosoh Corporation)
Particle size=5 μm
Size=7.8 mmID×30 cm×4

Carrier: Tetrahydrofuran (THF)

Detector: Parallax refraction

Sample: 1% Solution of THF/n-methylpyrrolidone=1/2

Calibration curve: Standard polystyrene

### (2) Average Particle Size:

Value of 50% cumulative percent in a particle size distribution curve measured with a laser particle size analyzer “Microtrack HRA” (a product of Nikkiso Co., Ltd.) was obtained.

### (3) High Temperature Melt Formability (Leveling Property):

A powder polyurethane resin was heat melted for 10 seconds in a mold heated to 230° C. After removing unmelted powder and allowing the melt to stand in a 300° C. oven for 45 seconds, a molded sheet having a thickness of 1 mm was prepared by slush molding with water cooling. The molten state of the sheet thus obtained was visually observed, and evaluated according to the following standards.

### Evaluation Standard

AA: Defective melting is not observed.

A: Defective melting is slightly observed to an extent such that it is not remarkable.

C: Defective melting is considerably observed.

### (4) High Temperature Melt Formability (Pinhole State):

Presence or absence, and the degree of pinhole on the surface of the sheet obtained in (3) above were visually observed, and evaluated according to the following standards.

### Evaluation Standard

AA: Pinhole is not observed.

A: Pinhole is slightly observed to an extent such that it is not remarkable.

C: Pinhole is considerably observed.

(5) High Temperature Melt Formability (Green Strength Development Property when demolding):

Presence or absence, and the degree of deformation when demolding the sheet obtained in (3) above were observed, and evaluated according to the following standards.

### Evaluation Standard

AA: Deformation is not observed.

A: Deformation is slightly observed.

C: Deformation is apparently observed.

### (6) Low Temperature Melt Formability (Leveling Property)

A powder polyurethane resin was heat melted for 10 seconds in a mold heated to 210° C. After removing unmelted powder and allowing the melt to stand in a 270° C. oven for 45 seconds, a molded sheet having a thickness of 1 mm was prepared by slush molding with water cooling. The molten state of the sheet thus obtained was visually observed, and evaluated according to the same standards as in (3) above.

### (7) Low Temperature Melt Formability (Pinhole State):

Presence or absence, and the degree of pinhole on the surface of the sheet obtained in (6) above were visually observed, and evaluated according to the same standards as in (4) above.

(8) Low Temperature Melt Formability (Green Strength Development Property when Demolding):

Presence or absence, and the degree of deformation when demolding the sheet obtained in (6) above were observed, and evaluated according to the same standards as in (5) above.

### (9) Surface Property of Molding (Crease Resistance of Molding):

The sheet obtained in (6) above was allowed to stand for 30 seconds after demolding, held in a 180° folded state for 30 seconds, returned to the unfolded state, and allowed to stand for 24 hours. The folded portion was visually observed, and evaluated according to the following standards.

### Evaluation Standard

AA: Crease is not observed.

A: Crease is slightly observed to an extent such that it is not remarkable.

C: Crease is apparently observed.

### (10) Surface Property of Molding (Abrasion Resistance):

The sheet obtained in (6) above was subjected to a test of 100 reciprocations using a reciprocating plane abrasion tester under the following conditions, and the state of sheet surface was visually observed, and evaluated according to the following standards.

### Conditions

Reciprocating speed: 40 times/min

Friction element: 30 mm×12 mm

Load: 29.4N

Abrasion material: Material obtained by laminating five white cotton shirting No. 3.

AA: Damage is not observed.

A: Damage is slightly observed to an extent such that it is not remarkable.

C: Damage is markedly observed.

### (11) Surface Property of Molding (Blooming Resistance):

The sheet obtained in (6) above was dipped in water at 50° C. for 48 hours, and then dried. Presence or absence, and the degree of blooming on the surface were visually observed, and evaluated according to the following standards.

### Evaluation Standard

AA: Blooming is not observed.

A: Blooming is slightly observed.

C: Blooming is markedly observed.

### (12) Mechanical Properties of Molding:

The sheet obtained in (6) above was subjected to a tensile test and a tear test according to JIS K 6251-6252, and tensile strength, elongation at break and tear strength were measured.

TABLE 7

| | | | Example | Example | Example | Example | Example | Example | Example |
|---|---|---|---|---|---|---|---|---|---|
| | | | II-1 | II-2 | II-3 | II-4 | II-5 | II-6 | II-7 |
| Number average molecular weight (Mn) | | | 26,000 | 29,000 | 35,000 | 37,000 | 38,000 | 45,000 | 22,000 |
| Weight average molecular weight (Mw) | | | 54,000 | 61,000 | 71,000 | 80,000 | 83,000 | 93,000 | 47,000 |
| Proportion of sparingly fusible material (PA %) | | | 3 | 4 | 8 | 17 | 20 | 17 | 4 |
| Average particle size (μm) | | | 150 | 150 | 150 | 150 | 150 | 150 | 150 |
| Melt | High | Leveling property | AA | AA | AA | AA | AA | AA | AA |
| formability | temperature | Pinhole state | AA | AA | AA | AA | AA | AA | AA |
| | | Green strength | A | A | AA | AA | AA | AA | A |
| | | development property | | | | | | | |
| | | when demolding | | | | | | | |
| | Low | Leveling property | AA | AA | AA | A | A | A | AA |
| | temperature | Pinhole state | AA | AA | AA | A | A | A | AA |
| | | Green strength | A | A | AA | AA | AA | AA | A |
| | | development property | | | | | | | |
| | | when demolding | | | | | | | |
| Surface | Crease resistance of molding | | A | A | AA | AA | AA | AA | A |
| property | Abrasion resistance of molding | | A | A | AA | AA | AA | AA | A |
| | surface | | | | | | | | |
| | Blooming resistance | | AA | AA | AA | AA | AA | AA | AA |
| Mechanical | Tensile strength (MPa) | | 15 | 16 | 18 | 13 | 12 | 16 | 12 |
| property | Elongation at break (%) | | 600 | 580 | 550 | 430 | 400 | 480 | 620 |
| | Tear strength (kN/m) | | 58 | 65 | 70 | 52 | 45 | 58 | 48 |
| | | | Example | Example | Example | Example | Example | Example | Example |
| | | | II-8 | II-9 | II-10 | II-11 | II-12 | II-13 | II-14 |
| Number average molecular weight (Mn) | | | 30,000 | 32,000 | 37,000 | 38,000 | 34,000 | 35,000 | 36,000 |
| Weight average molecular weight (Mw) | | | 65,000 | 68,000 | 75,000 | 77,000 | 70,000 | 71,000 | 73,000 |
| Proportion of sparingly fusible material (PA %) | | | 20 | 16 | 0 | 0 | 8 | 8 | 8 |
| Average particle size (μm) | | | 150 | 150 | 150 | 150 | 150 | 150 | 150 |
| Melt | High | Leveling property | AA | AA | AA | AA | AA | AA | AA |
| formability | temperature | Pinhole state | AA | AA | AA | AA | AA | AA | AA |
| | | Green strength | AA | AA | A | A | AA | AA | AA |
| | | development property | | | | | | | |
| | | when demolding | | | | | | | |
| | Low | Leveling property | A | AA | AA | AA | AA | AA | AA |
| | temperature | Pinhole state | A | AA | AA | AA | AA | AA | AA |
| | | Green strength | AA | AA | A | A | AA | AA | AA |
| | | development property | | | | | | | |
| | | when demolding | | | | | | | |

| | | | | | | | | |
|---|---|---|---|---|---|---|---|---|
| Surface | Crease resistance of molding | AA | AA | A | A | AA | AA | AA |
| property | Abrasion resistance of molding | AA | AA | A | A | AA | AA | AA |
| | surface | | | | | | | |
| | Blooming resistance | AA | AA | AA | AA | AA | AA | AA |
| Mechanical | Tensile strength (MPa) | 17 | 22 | 16 | 17 | 19 | 19 | 18 |
| property | Elongation at break (%) | 530 | 590 | 590 | 560 | 530 | 580 | 630 |
| | Tear strength (kN/m) | 60 | 71 | 65 | 63 | 71 | 67 | 65 |

TABLE 8

| | | | Comparative | Comparative | Comparative | Comparative | Comparative | Comparative | Comparative |
|---|---|---|---|---|---|---|---|---|---|
| | | | Example | Example | Example | Example | Example | Example | Example |
| | | | II-1 | II-2 | II-3 | II-4 | II-5 | II-6 | II-7 |
| Number average molecular weight (Mn) | | | 24,000 | 38,000 | 56,000 | 15,000 | 29,000 | 38,000 | 70,000 |
| Weight average molecular weight (Mw) | | | 50,000 | 86,000 | 128,000 | 32,000 | 64,000 | 76,000 | 180,000 |
| Proportion of sparingly fusible material (PA %) | | | 0 | 25 | 22 | 0 | 23 | 0 | 25 |
| Average particle size (μm) | | | 150 | 150 | 150 | 150 | 150 | 150 | 150 |
| Melt | High | Leveling property | AA | A | A | AA | A | AA | C |
| formability | temperature | Pinhole state | AA | A | A | AA | A | AA | C |
| | | Green strength | C | AA | AA | C | AA | C | AA |
| | | development | | | | | | | |
| | | property | | | | | | | |
| | | when demolding | | | | | | | |
| | Low | Leveling property | AA | C | C | AA | C | AA | C |
| | temperature | Pinhole state | AA | C | C | AA | C | AA | C |
| | | Green strength | C | AA | AA | C | AA | C | AA |
| | | development | | | | | | | |
| | | property | | | | | | | |
| | | when demolding | | | | | | | |

| | | | | | | | | |
|---|---|---|---|---|---|---|---|---|
| Surface | Crease resistance of molding | C | AA | AA | C | AA | C | AA |
| property | Abrasion resistance of molding | C | AA | AA | C | AA | C | AA |
| | surface | | | | | | | |
| | Blooming resistance | AA | AA | AA | AA | AA | AA | AA |
| Mechanical | Tensile strength (MPa) | 17 | 6 | 8 | 7 | 8 | 19 | 3 |
| property | Elongation at break (%) | 650 | 360 | 300 | 350 | 400 | 570 | 250 |
| | Tear strength (kN/m) | 55 | 35 | 25 | 35 | 40 | 55 | 20 |

| | | | Comparative | Comparative | Comparative | Comparative | Comparative | Comparative |
|---|---|---|---|---|---|---|---|---|
| | | | Example | Example | Example | Example | Example | Example |
| | | | II-8 | II-9 | II-10 | II-11 | II-12 | II-13 |
| Number average molecular weight (Mn) | | | 73,000 | 75,000 | 38,000 | *1) | 37,000 | 40,000 |
| Weight average molecular weight (Mw) | | | 172,000 | 164,000 | 79,000 | | 76,000 | 80,000 |
| Proportion of sparingly fusible material (PA %) | | | 22 | 20 | 8 | | 8 | 30 |
| Average particle size (μm) | | | 150 | 150 | 150 | — | 150 | 150 |
| Melt | High | Leveling property | C | C | AA | — | AA | C |
| formability | temperature | Pinhole state | C | C | AA | — | AA | C |
| | | Green strength | AA | AA | AA | — | AA | AA |
| | | development property | | | | | | |
| | | when demolding | | | | | | |
| | Low | Leveling property | C | C | AA | — | AA | C |
| | temperature | Pinhole state | C | C | AA | — | AA | C |
| | | Green strength | AA | AA | AA | — | AA | AA |
| | | development property | | | | | | |
| | | when demolding | | | | | | |

| | | | | | | | |
|---|---|---|---|---|---|---|---|
| Surface | Crease resistance of molding | AA | AA | AA | — | AA | AA |
| property | Abrasion resistance of molding | AA | AA | AA | — | AA | AA |
| | surface | | | | | | |
| | Blooming resistance | AA | AA | C | — | C | AA |
| Mechanical | Tensile strength (MPa) | 3 | 6 | 17 | — | 16 | 20 |
| property | Elongation at break (%) | 280 | 300 | 500 | — | 650 | 350 |
| | Tear strength (kN/m) | 22 | 24 | 67 | — | 62 | 60 |

*1) Molecular weight greatly varied every lot. This is considered to be due to evaporation of ethanol.

The above Examples II-1 to II-14 are all according to the production process (1) in the preferred production processes (1) to (4) according to the second invention.

Of the preferred production processes according to the second invention, powdered thermoplastic polyurethane urea resins were prepared by Examples II-15 to II-17 having the same formulation as in Example II-3 as the specific examples of the production processes (2) to (4), and each of the resins obtained was measured and evaluated on the above-described items (1) to (12). Those results are shown in Table 9 below together with the results of Example II-3. It is understood from the results shown in Table 9 that evaluation results of the resins obtained are good even thought any of the preferred production processes (1) (Example II-3) and (2) to (4) according to the second invention is employed.

### Example II-15

### (1) First Step

157.1 g of a polyester diol (PBA-1000), 235.7 g of a polyester diol (PBEA-2600), 235.7 g of polyester diol (PHiP-1000), 157.1 g of a polyester diol (PHoP-1500), 25.57 g of di-2-ethylhexylamine as the monofunctional active hydrogen-containing compound (c), 6.68 g of 1,4-BD as the bifunctional active hydrogen-containing compound (d), 3.75 g of 1,6-HD as the bifunctional active hydrogen-containing compound (d), 17.0 g of the dispersing agent solution (1) and 677.5 g of isooctane “KYOWA SOL C-800” (a product of Kyowa Hakko Chemical Co., Ltd.) as the non-aqueous dispersion medium were charged in a reactor having a volume of 3 liters equipped with a stirring device, a thermometer, a condenser and a nitrogen gas introduction pipe, and stirred at 90 to 95° C. for 1 hour to disperse the polymer polyol (a) (PBA-1000, PBEA-2600, PHiP-1000 and PHOP-1500) in isooctane, thereby preparing a non-aqueous dispersion.

### (2) Second Step

188.0 g of hexamethylene diisocyanate (HDI) as the organic polyisocyanate (b), and 0.051 g of a bismuth catalyst “NEOSTAN U-600” (a product of Nitto Chemical Industry Co., Ltd.) were added to the dispersion obtained in the first step to react the polymer polyol (a), HDI, di-2-ethylhexylamine, 1,4-BD and 1,6-HD at 90 to 95° C. for 3 hours, thereby forming an isocyanate-terminated prepolymer (I), and its dispersion was prepared.

### (3) Third Step

66.8 g of water (corresponding to 10 equivalents of the isocyanate group (calculated value) in the isocyanate-terminated prepolymer (I)) was added to the dispersion obtained in the second step. The isocyanate-terminated prepolymer and water were subjected to chain extension reaction at 65 to 70° C. until the isocyanate was consumed, thereby forming a polyurethane urea resin, and its dispersion was prepared.

x1, x2, x3 and A in this Example are the same as x1, x2, x3 and A in Example 11-3, respectively.

### (4) Fourth Step

A solid content (polyurethane urea resin) was filtered off from the dispersion obtained in the third step, and the additives (i) to (v) used in Example II-1 were added to the solid content (the respective addition amount was the same as in Example II-1). After drying the resulting mixture, 0.30 g of a dusty agent “MP1451” was added to the dried mixture to prepare a powdered thermoplastic polyurethane urea resin.

The resin obtained had a truly spherical shape and an angle of repose of 26°.

### (1) First Step:

157.1 g of a polyester diol (PBA-1000), 235.7 g of a polyester diol (PBEA-2600), 235.7 g of polyester diol (PHiP-1000), 157.1 g of a polyester diol (PHoP-1500), 6.68 g of 1,4-BD as the bifunctional active hydrogen-containing compound (d), 3.75 g of 1,6-HD as the bifunctional active hydrogen-containing compound (d), 17.0 g of the dispersing agent solution (1) and 677.5 g of isooctane “KYOWA SOL C-800” (a product of Kyowa Hakko Chemical Co., Ltd.) as the non-aqueous dispersion medium were charged in a reactor having a volume of 3 liters equipped with a stirring device, a thermometer, a condenser and a nitrogen gas introduction pipe, and stirred at 90 to 95° C. for 1 hour to disperse the polymer polyol (a) (PBA-1000, PBEA-2600, PHiP-1000 and PHoP-1500) in isooctane, thereby preparing a non-aqueous dispersion.

### (2) Second Step:

188.0 g of hexamethylene diisocyanate (HDI) as the organic polyisocyanate (b) and 0.051 g of a bismuth catalyst “NEOSTAN U-600” (a product of Nitto Chemical Industry Co., Ltd.) were added to the dispersion obtained in the first step to react the polymer polyol (a), HDI, 1,4-BD and 1,6-HD at 90 to 95° C. for 3 hours, thereby forming an isocyanate-terminated prepolymer, and its dispersion was prepared.

### (3) Pre-Step of Third Step:

25.57 g of di-2-ethylhexylamine as the monofunctional active hydrogen-containing compound (c) was added to the dispersion obtained in the second step to react the isocyanate-terminated prepolymer and 2-ethylhexylamine at 65 to 70° C., thereby forming an isocyanate-terminated prepolymer (I), and its dispersion was prepared.

### (4) Third Step:

66.8 g of water (corresponding to 10 equivalents of the isocyanate group (calculated value) in the isocyanate-terminated prepolymer (I)) was added to the dispersion obtained in the pre-step of the third step. The isocyanate-terminated prepolymer and water were subjected to chain extension reaction at 65 to 70° C. until the isocyanate was consumed, thereby forming a polyurethane urea resin, and its dispersion was prepared.

x1, x2, x3 and A in this Example are the same as x1, x2, x3 and A in Example 11-3, respectively.

### (5) Fourth Step:

A solid content (polyurethane urea resin) was filtered off from the dispersion obtained in the third step, and the additives (i) to (v) used in Example II-1 were added to the solid content (the respective addition amount was the same as in Example II-1). After drying the resulting mixture, 0.30 g of a dusty agent “MP1451” was added to the dried mixture to prepare a powdered thermoplastic polyurethane urea resin.

The resin obtained had a truly spherical shape and an angle of repose of 26°.

### (1) First Step:

157.1 g of a polyester diol (PBA-1000), 235.7 g of a polyester diol (PBEA-2600), 235.7 g of polyester diol (PHiP-1000), 157.1 g of a polyester diol (PHoP-1500), 17.0 g of the dispersing agent solution (1) and 677.5 g of isooctane “KYOWA SOL C-800” (a product of Kyowa Hakko Chemical Co., Ltd.) as the non-aqueous dispersion medium were charged in a reactor having a volume of 3 liters equipped with a stirring device, a thermometer, a condenser and a nitrogen gas introduction pipe, and stirred at 90 to 95° C. for 1 hour to disperse the polymer polyol (a) (PBA-1000, PBEA-2600, PHiP-1000 and PHoP-1500) in isooctane, thereby preparing a non-aqueous dispersion.

### (2) Second Step:

188.0 g of hexamethylene diisocyanate (HDI) as the organic polyisocyanate (b) and 0.051 g of a bismuth catalyst “NEOSTAN U-600” (a product of Nitto Chemical Industry Co., Ltd.) were added to the dispersion obtained in the first step. The polymer polyol (a) and HDI were reacted at 90 to 95° C. for 3 hours to form an isocyanate-terminated prepolymer, and its dispersion was prepared.

### (3) Pre-Step of Third Step:

25.57 g of di-2-ethylhexylamine as the monofunctional active hydrogen-containing compound (c), 6.68 g of 1,4-BD as the bifunctional active hydrogen-containing compound (d) and 3.75 g of 1,6-HD as the bifunctional active hydrogen-containing compound (d) were added to the dispersion obtained in the second step to react the isocyanate-terminated prepolymer, 2-ethylhexylamine, 1,4-BD and 1,6-HD at 65 to 70° C., thereby forming an isocyanate-terminated prepolymer (I), and its dispersion was prepared.

### (4) Third Step:

66.8 g of water (corresponding to 10 equivalents of the isocyanate group (calculated value) in the isocyanate-terminated prepolymer (I)) was added to the dispersion obtained in the pre-step of the third step. The isocyanate-terminated prepolymer and water were subjected to chain extension reaction at 65 to 70° C. until the isocyanate was consumed, thereby forming a polyurethane urea resin, and its dispersion was prepared.

x1, x2, x3 and A in this Example are the same as x1, x2, x3 and A in Example II-3, respectively.

### (5) Fourth Step:

A solid content (polyurethane urea resin) was filtered off from the dispersion obtained in the third step, and the additives (i) to (v) used in Example II-1 were added to the solid content (the respective addition amount was the same as in Example II-1). After drying the resulting mixture, 0.30 g of a dusty agent “MP1451” was added to the dried mixture to prepare a powdered thermoplastic polyurethane urea resin.

The resin obtained had a truly spherical shape and an angle of repose of 26°.

TABLE 9

| | | | Example | Example | Example | Example |
|---|---|---|---|---|---|---|
| | | | II-15 | II-16 | II-17 | II-3 |
| Number average molecular weight (Mn) | | | 35,000 | 36,000 | 36,000 | 35,000 |
| Weight average molecular weight (Mw) | | | 72,000 | 73,000 | 71,000 | 71,000 |
| Proportion of sparingly fusible material (PA %) | | | 8 | 8 | 8 | 8 |
| Average particle size (μm) | | | 150 | 150 | 150 | 150 |
| Melt | High | Leveling property | AA | AA | AA | AA |
| formability | temperature | Pinhole state | AA | AA | AA | AA |
| | | Green strength | AA | AA | AA | AA |
| | | development property | | | | |
| | | when demolding | | | | |
| | Low | Leveling property | AA | AA | AA | AA |
| | temperature | Pinhole state | AA | AA | AA | AA |
| | | Green strength | AA | AA | AA | AA |
| | | development property | | | | |
| | | when demolding | | | | |

| | | | | | |
|---|---|---|---|---|---|
| Surface | Crease resistance of molding | AA | AA | AA | AA |
| property | Abrasion resistance of molding | AA | AA | AA | AA |
| | surface | | | | |
| | Blooming resistance | AA | AA | AA | AA |
| Mechanical | Tensile strength (MPa) | 17 | 18 | 18 | 18 |
| property | Elongation at break (%) | 530 | 550 | 530 | 550 |
| | Tear strength (kN/m) | 65 | 65 | 70 | 70 |

### INDUSTRIAL APPLICABILITY

The powdered thermoplastic polyurethane urea resin obtained by the production process of the present invention is suitable as a powder material for slush molding. The slush molded product by the polyurethane urea resin is particularly suitable as interior materials of automobiles, and further useful as interior furniture such as sofa.

1. A process for producing a powdered thermoplastic polyurethane urea resin, including a step of forming a polyurethane urea resin by subjecting an isocyanate-terminated prepolymer (I) obtained by reacting a polymer polyol (a), an organic polyisocyanate (b) and a monofunctional active hydrogen-containing compound (c) having an active hydrogen group and a hydrocarbon group having from 4 to 12 carbon atoms, and water (e) to chain extension reaction in a non-aqueous dispersion medium,
wherein when the mole number of an active hydrogen group of the polymer polyol (a) subjected to the reaction is A, the mole number of the active hydrogen group of the monofunctional active hydrogen-containing compound (c) is x1, and the mole number of an active hydrogen group of water (e) is x3, the conditions shown by the following formulae (1) and (2) are satisfied;
0.3≦(x1+x3)/A1≦0.5 Formula (1)
5/95≦x1/x3≦35/65. Formula (2)

2. The process for producing a powdered thermoplastic polyurethane urea resin as claimed in claim 1, which includes the following first to fourth steps, wherein the monofunctional active hydrogen-containing compound (c) having an active hydrogen group and a hydrocarbon group having from 4 to 12 carbon atoms is reacted in the second step and/or as a pre-step of the third step;
First step: A step of dispersing the polymer polyol (a) in the non-aqueous dispersion medium to prepare a dispersion;
Second step: A step of adding the organic polyisocyanate (b) to the dispersion obtained by the first step and reacting the polymer polyol (a) and the organic polyisocyanate (b) to prepare a dispersion of the isocyanate-terminated prepolymer;
Third step: A step of adding water to the dispersion obtained by the second step or through a pre-step of the third step, subjecting the isocyanate-terminated prepolymer (I) and water (e) to chain extension reaction in the non-aqueous dispersion medium to form a polyurethane urea resin, and preparing its dispersion;
Fourth step: A step of separating and drying the polyurethane urea resin from the dispersion obtained by the third step to prepare a powdered thermoplastic polyurethane urea resin.

3. The process for producing a powdered thermoplastic polyurethane urea resin as claimed in claim 2, wherein the polymer polyol (a), the organic polyisocyanate (b) and the monofunctional active hydrogen-containing compound (c) are reacted in the second step.

4. The process for producing a powdered thermoplastic polyurethane urea resin as claimed in claim 2, wherein the monofunctional active hydrogen-containing compound (c) is added to the dispersion obtained by the second step to react the isocyanate-terminated prepolymer and the monofunctional active hydrogen-containing compound (c), as the pre-step of the third step.

5. The process for producing a powdered thermoplastic polyurethane urea resin as claimed in claim 5, wherein the ratio ((x1+x3)/A) is from 0.3 to 1.2, and the ratio (x1/x3) is (5 to 20)/(95 to 80).

6. The process for producing a powdered thermoplastic polyurethane urea resin as claimed in claim 4, wherein the ratio ((x1+x3)/A) is from 0.75 to 1.5, and the ratio (x1/x3) is (10 to 35)/(90 to 65).

7. The process for producing a powdered thermoplastic polyurethane urea resin as claimed in claim 1, wherein the organic polyisocyanate (b) is hexamethylene diisocyanate.

8. The process for producing a powdered thermoplastic polyurethane urea resin as claimed in of claim 1, wherein the monofunctional active hydrogen-containing compound (c) is a dialkyl amine.

9. The process for producing a powdered thermoplastic polyurethane urea resin as claimed in of claim 1, wherein the monofunctional active hydrogen-containing compound (c) is a monool.

10. The process for producing a powdered thermoplastic polyurethane urea resin as claimed in claim 1, which produces a powdered thermoplastic polyurethane urea resin for slush molding.

11. A process for producing a powdered thermoplastic polyurethane urea resin, including a step of forming a polyurethane urea resin by subjecting
an isocyanate-terminated prepolymer (II) obtained by reacting a polymer polyol (a), an organic polyisocyanate (b), a monofunctional active hydrogen-containing compound (c) having an active hydrogen group and a hydrocarbon group having from 4 to 12 carbon atoms, and a bifunctional active hydrogen-containing compound (d) having a number average molecular weight of less than 500, and
water (e)
to chain extension reaction in a non-aqueous dispersion medium,
wherein when the mole number of an active hydrogen group of the polymer polyol (a) subjected to the reaction is A, the mole number of the active hydrogen group of the monofunctional active hydrogen-containing compound (c) is x1, the mole number of an active hydrogen group of the bifunctional active hydrogen-containing compound (d) is x2, and the mole number of an active hydrogen group of water (e) is x3, the conditions shown by the following formulae (1) to (3) are satisfied;
0.3≦(x1+x2+x3)/A≦1.5 Formula (1)
5/95≦x1/(x2+x3)≦25/75 Formula (2)
3/97≦x2/x3≦67/33. Formula (3)

12. The process for producing a powdered thermoplastic polyurethane urea resin as claimed in claim 11, which includes the following first to fourth steps, wherein the monofunctional active hydrogen-containing compound (c) having an active hydrogen group and a hydrocarbon group having from 4 to 12 carbon atoms is reacted in the second step and/or as a pre-step of the third step, and additionally, the bifunctional active hydrogen-containing compound (d) having a number average molecular weight of less than 500 is reacted in the second step and/or as a pre-step of the third step;
First step: A step of dispersing the polymer polyol (a) in a non-aqueous dispersion medium to prepare a dispersion;
Second step: A step of adding the organic polyisocyanate (b) to the dispersion obtained by the first step and reacting the polymer polyol (a) and the organic polyisocyanate (b) to prepare a dispersion of the isocyanate-terminated prepolymer;
Third step: A step of adding water to the dispersion obtained by the second step or through a pre-step of the third step, subjecting the isocyanate-terminated prepolymer (II) and water (e) to chain extension reaction in the non-aqueous dispersion medium to form a polyurethane urea resin, and preparing its dispersion;
Fourth step: A step of separating and drying the polyurethane urea resin from the dispersion obtained by the third step to prepare a powdered thermoplastic polyurethane urea resin.

13. The process for producing a powdered thermoplastic polyurethane urea resin as claimed in claim 12, wherein in the second step, the polymer polyol (a), the organic polyisocyanate (b) and the monofunctional active hydrogen-containing compound (c) are reacted to prepare a dispersion of the isocyanate-terminated prepolymer, and as the pre-step of the third step, the bifunctional active hydrogen-containing compound (d) is added to the dispersion obtained in the second step to react the isocyanate-terminated prepolymer and the bifunctional active hydrogen-containing compound (d).

14. The process for producing a powdered thermoplastic polyurethane urea resin as claimed in claim 12, wherein the polymer polyol (a), the organic polyisocyanate (b), the monofunctional active hydrogen-containing compound (c) and the bifunctional active hydrogen-containing compound (d) are reacted in the second step.

15. The process for producing a powdered thermoplastic polyurethane urea resin as claimed in claim 12, wherein in the second step, the polymer polyol (a), the organic polyisocyanate (b) and the bifunctional active hydrogen-containing compound (d) are reacted to prepare a dispersion of the isocyanate-terminated prepolymer, and as the pre-step of the third step, the monofunctional active hydrogen-containing compound (c) is added to the dispersion obtained by the second step to react the isocyanate-terminated prepolymer and the monofunctional active hydrogen-containing compound (c).

16. The process for producing a powdered thermoplastic polyurethane urea resin as claimed in claim 12, wherein as the pre-step of the third step, the monofunctional active hydrogen-containing compound (c) and the bifunctional active hydrogen-containing compound (d) are added to the dispersion obtained by the second step to react the isocyanate-terminated prepolymer, the monofunctional active hydrogen-containing compound (c) and the bifunctional active hydrogen-containing compound (d).

17. The process for producing a powdered thermoplastic polyurethane urea resin as claimed in of claim 1, wherein the organic polyisocyanate (b) is hexamethylene diisocyanate.

18. The process for producing a powdered thermoplastic polyurethane urea resin as claimed in of claim 1, which produces a powdered thermoplastic polyurethane urea resin for slush molding.
